(19) United States
(12) Patent Application Publication
(10) Pub. No.: US 2026/0288838 A1
(43) Pub. Date: Sep. 24, 2026

(54) SYSTEM

(71) Applicant: SoftBank Group Corp., Tokyo (JP)

(72) Inventor: Tomohiro YOSHINO, Tokyo (JP)

(73) Assignee: SoftBank Group Corp., Tokyo (JP)

(21) Appl. No.: 19/567,055

(22) Filed: Mar. 14, 2026

(30) Foreign Application Priority Data
Mar. 19, 2025 (JP) 2025-045233

(51) Int. Cl. G06F 16/335; G06F 16/332

(52) U.S. Cl. CPC G06F 16/337; G06F 16/332

(57) ABSTRACT

A system includes a processor that is configured to detect an operation by a user to set a flag on digital content in which the user has an interest, and to collect metadata of the digital content and convert the metadata into structured data, store the structured metadata in a storage device, and, when the user performs a search, retrieve corresponding information from the storage device, and generate a prompt for instructing a generative AI model to recommend new information related to the user, based on past interests and emotional states of the user.

### CROSS-REFERENCE TO RELATED APPLICATION

This application is based on and claims priority under 35 USC 119 from Japanese Patent Application No. 2025-045233 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information management and recommendation systems generally store user interaction logs, such as “likes” or “favorites,” and may return previously stored items in response to a user search. However, these systems often fail to (i) systematically capture and structure metadata at the time a user flags digital content, (ii) flexibly retrieve such stored information in a way that tightly reflects a user's evolving interests and search intent, and (iii) leverage generative AI models in a controlled manner to produce new, contextually relevant recommendations that consider both past interests and the emotional state of the user. As a result, users are frequently presented with recommendations that are generic, insufficiently personalized, or only weakly related to the content they have explicitly indicated as interesting. Furthermore, existing systems typically do not generate explicit prompts tailored for generative AI models, which reduces controllability, explainability, and consistency of AI-generated recommendations. There is therefore a need for a system that: detects user flagging operations on digital content, automatically structures and stores corresponding metadata, retrieves stored information in response to user search queries, and generates suitable prompts for generative AI models so that highly personalized, emotion-aware, and contextually related information can be recommended to the user.

### SUMMARY

In order to solve the above-described problems, an embodiment of the present invention provides a system comprising a processor, wherein the processor is configured to detect an operation by a user to set a flag on digital content in which the user has an interest, and to collect metadata of the digital content and convert the metadata into structured data. The processor is further configured to store the structured metadata in a storage device and, when the user performs a search, retrieve corresponding information from the storage device based on a search query of the user. In addition, the processor is configured to generate a prompt for instructing a generative AI model to recommend new information related to the user, the prompt being generated based on past interests and emotional states of the user. In one embodiment, the processor is configured to provide personalized content to the user based on an emotion of the user, the content including at least one of text, an image, audio, a video, and a combination thereof. In another embodiment, the processor is configured to further recommend information based on the prompt generated for instructing the generative AI model to recommend related information, thereby enabling the system to deliver highly relevant and emotion-aware recommendations that reflect both stored, user-flagged content and dynamically generated related information.

The term “system” refers to an integrated combination of hardware and software components, including at least one processor and one or more storage devices, that cooperatively perform the functions described in the claims.

The term “processor” refers to one or more hardware processing units, such as a central processing unit (CPU), graphics processing unit (GPU), application-specific integrated circuit (ASIC), or programmable logic device, that execute instructions to implement the configured operations of the claimed system.

The term “user” refers to a human individual who interacts with the system, including performing operations such as flagging digital content and issuing search queries.

The term “digital content” refers to electronically stored or transmitted content, including but not limited to text, images, audio, videos, and any combination thereof, that can be presented to the user via an electronic device.

The term “flag” refers to an explicit indication, generated by a user operation, that marks particular digital content as being of interest to the user, such as a like, favorite, bookmark, save, or similar marking operation.

The term “operation by a user to set a flag” refers to an input action performed by the user, such as clicking, tapping, or selecting a user interface element, that causes the system to register that specific digital content is of interest to the user.

The term “metadata” refers to descriptive information associated with digital content, including but not limited to a title, URL, author, creation time, content type, tags, summary, and other attributes that characterize or identify the digital content.

The term “structured data” refers to metadata that has been converted into a predefined data format or schema, such as a set of fields or records in a database, thereby enabling systematic storage, retrieval, and processing by the system.

The term “storage device” refers to any non-transitory computer-readable medium or collection of media, including but not limited to hard disk drives, solid-state drives, semiconductor memory, or distributed storage systems, that stores the structured metadata and other information used by the system.

The term “search” refers to a process initiated by the user, in which the system receives a search query and attempts to locate and retrieve corresponding information from the storage device.

The term “search query” refers to input data provided by the user, such as a keyword, phrase, or other query expression, that specifies a condition or criterion for retrieving relevant information from the storage device.

The term “corresponding information” refers to one or more records, items, or data sets stored in the storage device whose attributes satisfy a condition derived from the user's search query or other retrieval criteria.

The term “generative AI model” refers to a machine learning model, such as a large language model, image generation model, or multimodal generation model, that is capable of producing new content or recommendations based on input data and instructions.

The term “prompt” refers to a structured instruction, message, or input sequence provided to the generative AI model, the content of which specifies a task, context, or constraint for the generative AI model to generate new information or recommendations.

The term “past interests” refers to information indicating the user's historical preferences, behaviors, or selections, including but not limited to previously flagged digital content and associated metadata.

The term “emotional states of the user” refers to inferred or detected emotional conditions of the user, such as happiness, sadness, stress, or excitement, derived from user interactions, explicit input, or other signals processed by the system.

The term “new information” refers to information that was not previously stored as user-flagged metadata in the storage device, and that is generated, selected, or recommended by the system or the generative AI model as being related to the user's interests and emotional states.

The term “personalized content” refers to content that is selected, generated, or adapted by the system for a specific user, based at least on the user's past interests and emotional states, so that the content is tailored to that particular user.

The term “related information” refers to information, including but not limited to digital content or metadata, that has a contextual, topical, semantic, or emotional relationship to digital content previously indicated as interesting by the user or to the user's current search query.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

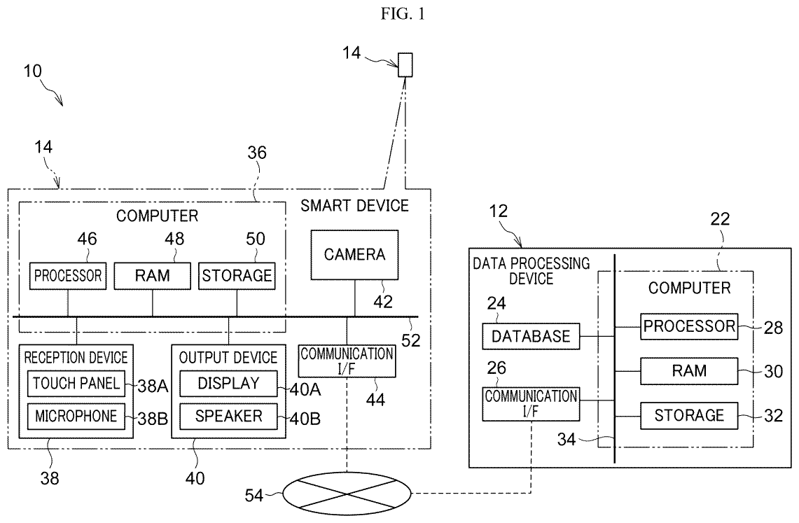

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

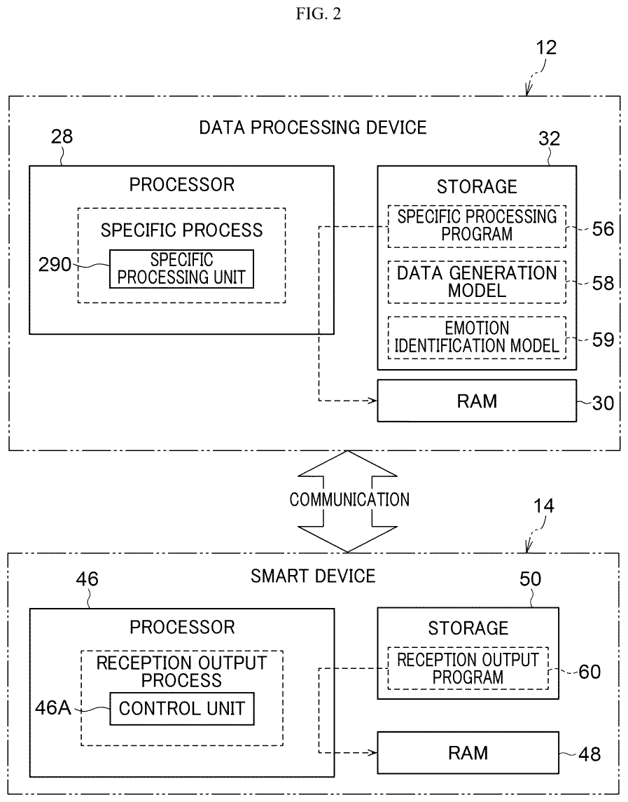

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional content bookmarking and recommendation systems typically store user-selected items as simple records in a local or remote data store and subsequently perform keyword- or category-based retrieval. In such systems, a client device often sends only coarse identifiers (for example, a content ID or a bare URL) to a server, and the server maintains flat lists of bookmarked items. As a result, the server lacks sufficiently structured metadata to perform sophisticated processing, such as generating context-aware prompts for a generative information processing model, and cannot effectively leverage the user's detailed interest history or emotional state. Moreover, existing architectures usually treat recommendation logic and data acquisition logic as loosely coupled components, causing inefficiencies in data flow, duplicated processing, and increased latency when generating personalized recommendations.

From the viewpoint of computer technology, this leads to several technical problems. First, the absence of standardized, structured metadata pipelines between terminals and servers causes redundant parsing and transformation operations on the server side, increasing processor load and memory footprint. Second, the lack of tight integration between storage of user-specific metadata and the generation of input prompts for a generative information processing model prevents efficient use of server resources, because the server must repeatedly aggregate and normalize disparate data sources at query time. Third, prior systems do not systematically encode user interest tendencies and emotional attributes into machine-readable representations that are directly consumable by generative models, thereby limiting the system's ability to generate high-quality recommendations without incurring additional computation and network overhead.

Accordingly, there is a need for an improved computer-implemented system that, at the time of a user's flagging operation on electronic information, acquires and normalizes rich associated information into a structured data format, stores such information in an external information storage device in a manner that is organized per user and per event, and later uses this stored information to algorithmically construct instruction sentences for a generative information processing model. Such a system should improve the efficiency of server-side data processing, reduce redundant transformations, and enhance the accuracy and responsiveness of generating or recommending new related information that reflects the user's past interest tendencies and emotional state. The technical challenge is therefore to design a server-side control mechanism and data structure that integrate (i) real-time ingestion of structured metadata from terminals, (ii) per-user management of such metadata in external storage, and (iii) automatic construction and refinement of model-ready instruction sentences for a generative information processing model, thereby improving the overall operation of the computer system itself.

The specific processing by the specific processing unit 290 of the data processing device 12 in Example 1 is realized by the following means.

The present invention provides a server comprising a processor configured to detect, from an information processing terminal, a flagging operation performed by a user on electronic information displayed on the information processing terminal, acquire associated information including identification information, presentation information, and reference information corresponding to the electronic information from the information processing terminal, and convert the associated information into a structured data format; to add user identification information and time information to the associated information converted into the structured data format, transmit the associated information with the user identification information and the time information to an external information storage device via a communication network, and register the associated information as stored information managed on a per-user basis in the external information storage device; to receive a retrieval request based on the user identification information, acquire the stored information from the external information storage device in response to the retrieval request, generate list information using the associated information included in the stored information, and transmit the list information to the information processing terminal; and to generate an instruction sentence to be input to a generative information processing model based on the stored information and the retrieval request so that the instruction sentence instructs generation or recommendation of new related information associated with a past interest tendency and an emotional state of the user. This enables the server to implement a unified, machine-readable metadata pipeline that reduces redundant data transformations, improves the efficiency and scalability of storage and retrieval operations in the external information storage device, and automatically produces optimized instruction sentences for the generative information processing model, thereby enhancing the technical performance of the overall computer system in generating and delivering personalized recommendations.

The term “system” refers to a combination of one or more hardware devices and software components that cooperate to perform information processing, communication, storage, and control operations as described in the claims.

The term “processor” refers to hardware circuitry, such as a central processing unit, a microprocessor, or a processing core, that executes instructions of a program to perform logical operations, arithmetic operations, control operations, and data transfer operations.

The term “information processing terminal” refers to an end-user computing device, such as a mobile device, a tablet device, a desktop device, or any other computing apparatus, that presents electronic information to a user and transmits and receives data via a communication network.

The term “user” refers to a human operator or an entity that interacts with the information processing terminal to view, flag, search for, or otherwise operate on electronic information.

The term “electronic information” refers to information represented in a digital form, including but not limited to text information, image information, sound information, moving image information, and any combination thereof.

The term “flagging operation” refers to an operation performed by a user via the information processing terminal to indicate interest in or selection of particular electronic information, including but not limited to an operation corresponding to a “like,” “favorite,” “save,” or similar user interface control.

The term “associated information” refers to information that describes or is linked to the electronic information, including identification information, presentation information, reference information, and any metadata used to characterize or retrieve the electronic information.

The term “identification information” refers to data that uniquely or distinctively identifies specific electronic information, such as an identifier, a resource locator, an index value, or any other distinguishing code.

The term “presentation information” refers to data used to present or display the electronic information to the user, such as a title, a summary, a thumbnail, a caption, or any other visual or textual representation.

The term “reference information” refers to data that enables access to or retrieval of the electronic information, such as a network address, a resource path, a link, or any other reference that can be used to obtain the electronic information.

The term “structured data format” refers to a data representation having a predefined structure, such as a hierarchical or relational arrangement, including but not limited to a markup format, a serialized object format, a tabular format, or any format enabling machine parsing and processing.

The term “user identification information” refers to data that uniquely or distinctively identifies a user or an account associated with the user, such as a user ID, an account ID, or an authentication identifier.

The term “time information” refers to data indicating a time or temporal attribute associated with an event, such as a timestamp, a date, a time of day, or a chronological sequence value.

The term “communication network” refers to any wired or wireless data communication infrastructure that enables data exchange between the information processing terminal, the server, and the external information storage device.

The term “external information storage device” refers to a storage apparatus or storage service distinct from the information processing terminal and the processor, which is accessible via a communication network and configured to store and manage information, including remote storage systems and cloud-based storage systems.

The term “stored information” refers to associated information, together with related metadata, that has been registered and retained in the external information storage device for later retrieval and processing.

The term “per-user basis” refers to a management scheme in which stored information is associated with, organized by, or partitioned according to individual users or user identification information.

The term “retrieval request” refers to a request received from the information processing terminal or another component to obtain stored information, the request including user identification information, search terms, condition information, or other retrieval parameters.

The term “list information” refers to information representing a collection or set of electronic information items or stored information items, typically including summary portions of associated information for presentation to the user.

The term “generative information processing model” refers to a computational model, such as a machine learning model or an artificial intelligence model, configured to generate or transform information, including text information, image information, sound information, moving image information, or combinations thereof, based on input data.

The term “instruction sentence” refers to one or more machine-readable or human-readable expressions, including a prompt or command, that specify conditions, context, or requirements for processing by the generative information processing model.

The term “new related information” refers to information generated or recommended by the generative information processing model that has a relationship to the stored information, the user's past interest tendency, or the user's emotional state, and that was not explicitly stored as part of the original associated information.

The term “past interest tendency” refers to a pattern of user preferences or behaviors inferred from historical flagging operations, retrieval requests, or interactions with electronic information.

The term “emotional state” refers to an affective condition or emotional attribute associated with the user or with the user's interactions, which may be inferred from user behavior, content attributes, or other signals and represented in a form suitable for machine processing.

The term “type of the electronic information” refers to a classification of electronic information according to its content category or semantic category, such as news, entertainment, educational content, or other content classes.

The term “representation format” refers to a format in which electronic information is expressed, including but not limited to text format, image format, sound format, moving image format, or combinations thereof.

The term “emotion-related attribute” refers to a feature or label indicating an emotional tone, sentiment, mood, or similar affective characteristic associated with the electronic information or the user's reaction to the electronic information.

The term “personalized information” refers to information that is generated or recommended based at least in part on individual user characteristics, including past interest tendency, emotional state, or user-specific preferences, such that the information differs among users.

The term “search term” refers to a word, phrase, or symbol included in a retrieval request and used as a basis for searching or filtering stored information.

The term “condition information” refers to parameters other than a search term that constrain or direct retrieval or recommendation, including but not limited to time conditions, category conditions, ranking conditions, or relevance thresholds.

The term “analysis result” refers to data obtained by processing a retrieval request, stored information, or other inputs, such as parsed search terms, extracted conditions, relevance scores, or classification outcomes, which are used to modify or refine an instruction sentence.

The term “degree of match” refers to a quantitative or qualitative measure indicating how well particular information satisfies a retrieval request, including similarity scores, ranking values, or other indicators of correspondence.

The term “relatedness” refers to a relationship between particular information and the stored information, based on content similarity, shared attributes, user behavior patterns, or other correlation measures.

In one embodiment, a server, a terminal, and a communication network cooperate to implement a system for capturing user flagging operations on electronic information, storing associated metadata as structured data in an external information storage device, and generating instruction sentences for a generative AI model to provide new related information. The server comprises at least one processor, a memory storing executable instructions, a network interface, and access to one or more external storage services implemented as cloud storage. The terminal comprises a processor, a memory, a user interface, and a communication module. The user interacts with the terminal to view and flag electronic information.

The terminal presents electronic information to the user using a display unit driven by a graphical user interface framework. The terminal executes application software, such as a native application or a web browser, implemented for example using platforms including Android, iOS, or a desktop operating system. The terminal uses standard UI frameworks (for example, event listeners, UI components, and rendering engines) to render “like,” “favorite,” and “save” controls associated with electronic information. The user performs a flagging operation by activating one of these controls.

The terminal detects the flagging operation by monitoring UI events and generates an internal representation of the event that includes a reference to the electronic information. The terminal accesses an in-memory data model or a document object model to obtain associated information, including an identifier of the electronic information, a title or other presentation information, a hyperlink or network address as reference information, and optional thumbnail or preview data. The terminal converts the associated information into a structured data format, such as JSON. The terminal attaches user identification information and time information to the structured data. The terminal then transmits this structured data to the server via a communication network using a secure transport protocol.

The server receives the structured data via a network interface implementing standard internet protocols. The server parses the structured data using a JSON parsing library or a similar structured data parser and validates the presence and format of required fields, such as user identification information, content identification information, and time information. The server enriches the received associated information with server-generated identifiers, including a record identifier and a server-side timestamp. The server maps the associated information into internal data structures, such as key-value maps, relational tuples, or document objects, suitable for storage in an external information storage device.

The server interacts with the external information storage device using a storage client library or software development kit. The server stores the structured associated information in the external storage device with keys or identifiers that encode at least a user identifier and a record identifier. The server also registers a corresponding entry in a database, such as a relational database or a NoSQL database, in which stored information is managed on a per-user basis. The server maintains indices on user identifiers and time information to support fast retrieval. This architecture improves data management by enforcing consistent data schemas and by enabling efficient indexing and lookup operations across large volumes of user-specific metadata.

The server receives retrieval requests from the terminal that include user identification information and optional search terms or condition information. The server authenticates the user and then queries the external information storage device and the database for stored information corresponding to the user. The server composes list information from the associated information contained in the stored information, selecting fields such as titles, thumbnails, and content links, and orders them according to time information or relevance criteria. The server transmits the list information to the terminal in a structured format for rendering on the user interface. This arrangement enables the terminal to render a “saved items” or “favorites” view with reduced local computation, because the server has already organized and filtered the data.

The server further generates instruction sentences to be input to a generative AI model based on the stored information and retrieval requests. In one embodiment, the server uses a neural network-based generative AI model, such as a transformer architecture with an encoder-decoder or decoder-only configuration. The server constructs a feature representation from stored information, including categorical features derived from types of electronic information, numerical features derived from time information and interaction frequency, and vector representations of titles and descriptions obtained by text embedding models. The server also encodes emotion-related attributes, such as sentiment scores or affective labels derived from content analysis or user reaction patterns.

The server applies a rule set and a prompt template to transform the feature representation into an instruction sentence in natural language. The server, for example, concatenates a description of the user's past interest tendency, a summary of recent flagged items, and constraints derived from the retrieval request. The server includes explicit directives about content type and representation format requested from the generative AI model. An example of a prompt sentence is:

“Generate three new article recommendations related to the user's recently saved technology and science articles with positive sentiment, and describe why each article matches the user's past interests.”

Another example of a prompt sentence is:

“Based on the user's previously saved music videos with energetic and upbeat emotional tone, suggest new music video content with similar style and explain the emotional characteristics.”

The server configures the generative AI model with parameters including a number of layers, attention heads, hidden dimension size, and activation functions. The server stores learned weights obtained through pre-training on large text corpora and optionally performs fine-tuning using sequences of instruction sentences and corresponding target outputs specific to the domain of electronic information. The server uses a training algorithm, such as stochastic gradient descent or an adaptive variant, with a loss function such as cross-entropy for next-token prediction during training, and updates the weights according to backpropagation.

The server, in one embodiment, defines specific tokenization rules for instruction sentences, including special tokens that mark sections corresponding to user interest summaries, emotional state descriptors, and retrieval constraints. The server uses these tokens as part of the input sequence to the generative AI model to improve the model's ability to separate and attend to different types of information. This non-conventional token structure represents a specific technical adaptation to the underlying model that enhances prompt interpretability and improves the quality and consistency of generated outputs in this system.

The server can also implement a secondary scoring module that evaluates candidate outputs from the generative AI model. The server computes similarity scores between candidate outputs and stored information using vector similarity metrics and computes additional scores based on estimated emotional alignment and coverage of requested categories. The server applies a ranking algorithm that combines these scores and selects final recommendations.

This scoring step constrains the behavior of the generative AI model in a way that reduces noise and improves precision, thereby contributing to technical improvements in accuracy and reliability of the system.

The server improves processing speed and computational efficiency by organizing stored information in a manner optimized for prompt construction. For example, the server maintains per-user summary vectors that aggregate features of stored information, such as cluster centroids of content embeddings and averaged emotional vectors. When generating a new instruction sentence, the server can reuse these precomputed summaries instead of reprocessing all stored items. This design reduces the number of database accesses and the amount of feature computation required at query time, resulting in faster response times and lower processor load.

The server also reduces communication load between the server and the terminal by avoiding transmission of full content metadata when only summary information is needed for prompt construction. The server can generate instruction sentences internally using stored information that is already present in the external information storage device and in server-side caches, thus limiting data transfers to the terminal to the final list information and generated recommendation outputs.

The terminal benefits from this architecture by offloading complex prompt generation and model inference operations to the server. The terminal needs only to monitor flagging operations, collect associated information, and render list information and recommendations received from the server. The terminal does not require a local generative AI model or heavy computation, which allows the system to operate on resource-constrained devices such as smartphones and tablets while still providing advanced recommendation functionality.

The user interacts with the system by performing flagging operations and issuing retrieval requests through intuitive user interface components. The user does not need to manually manage or organize saved electronic information, because the server and external information storage device automatically structure, store, and index the associated information. The user receives recommendations that are generated through analysis of past interest tendencies and emotional attributes, which the server implements using structured features and model-specific input formatting rather than simple heuristic or keyword-based rules.

In alternative embodiments, the server can employ different types of generative AI models, such as sequence-to-sequence models, diffusion-based generative models for images, or hybrid architectures that combine a text-based transformer with a separate embedding model for multimedia content. In each case, the server adapts the instruction sentence format and feature construction accordingly, but the core design namely, the integration of per-user structured stored information, algorithmic prompt generation, and external storage management remains consistent.

In another embodiment, the server implements a rule-based pre-processing stage that normalizes associated information before it is stored. The server, for example, maps different content categories into a unified taxonomy, normalizes URLs to canonical forms, and standardizes time information to a coordinated time reference. These rules are specific to the system and are designed to minimize data variability and improve downstream machine processing. This normalization leads to lower error rates during retrieval and more coherent aggregation of user interest tendencies.

In yet another embodiment, the server partitions the external information storage device into logical segments by user and by content type. The server uses different compression or data layout strategies for text-dominant versus media-dominant associated information. For text-dominant data, the server can store compact tokenized representations, while for media-dominant data, the server can store lightweight descriptors and references to media files.

These structural choices contribute to reduced storage footprint and faster access paths tailored to the characteristics of the respective data types.

The described system thus goes beyond merely automating human selection or recommendation tasks. The server specifically structures and indexes electronic information in a way that is optimized for generative AI processing, defines specialized prompt structures, and uses precomputed summaries and model-oriented features to improve the performance of the computing system. The technical effects include improved processing speed, reduced resource consumption, enhanced accuracy and relevance of generated recommendations, and reduced communication overhead in networked environments. Through these measures, the system achieves an improvement in computer technology itself, rather than merely implementing a business process using generic computing components.

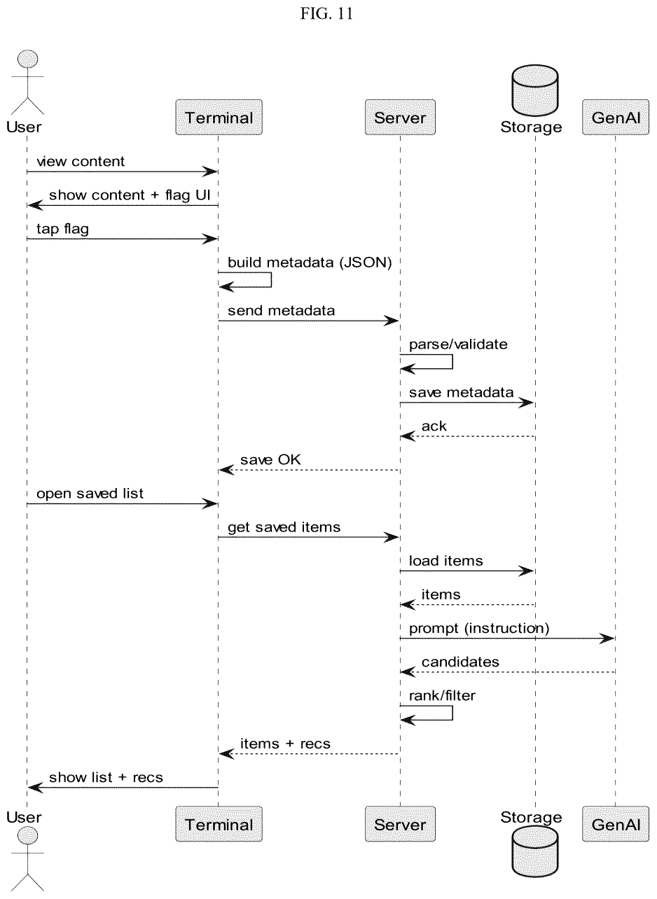

The following describes the processing flow using FIG. 11.

### Step 1:

The user views electronic information on the terminal.

The user operates the terminal to open an application or a web page and to display electronic information such as an article, an image, a sound clip, or a moving image.

Input: The input is content data and layout data received by the terminal from a server or a content provider over a network.

Output: The output is a rendered screen on the terminal's display that includes the electronic information and one or more user interface elements for flagging (for example, “like,” “favorite,” or “save” buttons).

The terminal uses a graphical user interface framework to render the content and to place interactive controls on the screen, binding each control to a specific content identifier or reference.

### Step 2:

The user performs a flagging operation on the terminal.

The user taps or clicks a “like,” “favorite,” or “save” control associated with the displayed electronic information.

Input: The input is the currently displayed screen state, including the association between visual controls and underlying content identifiers.

Output: The output is a UI event object inside the terminal, representing that the user has performed a flagging operation on particular electronic information.

The terminal captures this UI event through an event listener mechanism and records which control was activated, the type of flag, and the identity of the underlying content.

### Step 3:

The terminal extracts associated information for the flagged electronic information.

The terminal accesses an in-memory data model or a document object model to retrieve identification information (for example, a content ID or network address), presentation information (for example, a title or summary), and reference information (for example, a link or content path) corresponding to the flagged electronic information.

Input: The input is the UI event object including the reference to the flagged content and the data structures that describe the current content (for example, content objects or DOM nodes).

Output: The output is a set of associated information fields, such as content ID, title, summary, thumbnail reference, and link.

The terminal reads values from the data model, maps them into a defined metadata schema, and may perform simple transformations, such as trimming strings or normalizing URLs.

### Step 4:

The terminal converts the associated information into a structured data format.

The terminal creates a structured representation, such as a JSON object, into which the identification information, presentation information, and reference information are inserted as fields.

Input: The input is the set of associated information fields and user identification information stored on the terminal (for example, an account ID or token).

Output: The output is structured data that includes associated information, user identification information, and locally generated time information.

The terminal generates a timestamp, attaches the user identifier, and serializes the structured data using a JSON library, producing a text-based representation that can be transmitted over a network and parsed by the server.

### Step 5:

The terminal transmits the structured data to the server.

The terminal constructs a network request containing the structured data and sends it over a communication network to the server using a secure protocol.

Input: The input is the serialized structured data and network configuration parameters (for example, the server endpoint, authentication token, and headers).

Output: The output is a network message sent to the server and an acknowledgment or response message received from the server.

The terminal opens a secure connection, writes the structured data to the request body, sets appropriate headers, and initiates transmission; when a response is received, the terminal stores the response status and may update a local state or UI indicator.

### Step 6:

The server receives and parses the structured data.

The server accepts the network request, reads the request body, and decodes the structured data using a parser compatible with the format used by the terminal.

Input: The input is the network message containing structured data, including associated information, user identification information, and time information.

Output: The output is an internal server-side data object that represents the same associated information in a server-native data structure.

The server verifies message integrity, authenticates the user based on user identification information or tokens, and then maps the parsed fields into internal objects or records, performing validation checks (for example, mandatory field presence, format checks, and type checks).

### Step 7:

The server enriches and indexes the associated information.

The server generates a unique record identifier and adds a server-side timestamp to the internal data object. The server then associates the record with indexing keys, such as user identifier and time information, for efficient retrieval.

Input: The input is the internal data object containing validated associated information and user identification information.

Output: The output is an enriched data object that includes a record identifier, server-side timestamp, and index keys.

The server applies an identifier generation algorithm (for example, random or sequential ID generation) and builds index entries, such as key-value pairs or relational index entries, that connect the record identifier to the user and to temporal attributes.

### Step 8:

The server stores the enriched data in an external information storage device and a database.

The server uses a storage client to write the enriched data to an external information storage device and registers a corresponding entry in a database that manages stored information on a per-user basis.

Input: The input is the enriched data object and connection parameters for the external information storage device and the database.

Output: The output is a stored record in the external information storage device and a database record referencing that stored record.

The server serializes the enriched data into a storage-appropriate format, computes a storage key that includes the user identifier and record identifier, sends a write operation to the external storage, and then inserts or updates a database row or document containing the storage key, user identifier, and selected metadata fields for indexing and later retrieval.

### Step 9:

The server returns a confirmation to the terminal.

The server constructs a response message that indicates the success or failure of the storage operation and may include the record identifier or other metadata for reference.

Input: The input is the result of the storage operations, including acknowledgment from the external information storage device and the database.

Output: The output is a response message returned to the terminal that includes a status code and optional data such as the record identifier.

The server sets appropriate response fields based on the operation outcome, logs the transaction, and transmits the response over the communication network to the terminal.

### Step 10:

The terminal updates the user interface to reflect successful saving.

The terminal receives the response, interprets the status information, and updates the graphical user interface accordingly, for example by changing the appearance of the flagging control or displaying a notification.

Input: The input is the server response containing status information and, optionally, the record identifier.

Output: The output is an updated UI state on the terminal, indicating that the electronic information has been saved.

The terminal maps the success or error status to a visual change, such as highlighting the “favorite” icon or showing a short message, and may store the record identifier locally for temporary reference.

### Step 11:

The user later issues a retrieval request on the terminal.

The user navigates to a “saved items” or “favorites” screen and optionally enters a search term or selects filter conditions.

Input: The input is user interaction events corresponding to navigation to the retrieval interface and optional search parameters.

Output: The output is a retrieval request object within the terminal that encodes user identification information, search terms, and condition information.

The terminal collects the current user identifier, constructs a query structure that includes filters or ordering preferences, and prepares this data for transmission to the server.

### Step 12:

The terminal sends the retrieval request to the server.

The terminal encapsulates the retrieval request object in a network message and transmits it to the server using a secure protocol.

Input: The input is the retrieval request object containing user identification information and optional search parameters.

Output: The output is a network message delivered to the server requesting stored information for the user.

The terminal maps the internal request structure to request parameters (for example, URL query parameters or a request body), sets headers, initiates the network call, and waits for a response.

### Step 13:

The server processes the retrieval request and obtains stored information.

The server parses the retrieval request, authenticates the user based on user identification information, and queries the database and external information storage device for records corresponding to the user and matching any search conditions.

Input: The input is the retrieval request message, including user identification information, search terms, and condition information, and the contents of the database and external storage.

Output: The output is a collection of stored information records, each containing associated information for previously flagged electronic information.

The server constructs query expressions using user identifiers and condition information, executes these queries against indices, and assembles the resulting records into an internal list structure.

### Step 14:

The server generates list information for display on the terminal.

The server selects fields from each stored record, such as title, thumbnail, and reference link, and composes list information suitable for presentation on the terminal.

Input: The input is the collection of stored information records retrieved from the database and external storage.

Output: The output is structured list information representing saved electronic information items for the user.

The server may sort the list by time information or relevance scores, truncate or format text fields to fit UI constraints, and package the results into a structured response format, such as a JSON array of item descriptors.

### Step 15:

The server constructs an instruction sentence for the generative AI model.

The server analyzes the stored information and the retrieval request to extract features such as content types, categories, emotional attributes, and temporal patterns of past flagging operations, and then combines these features into an instruction sentence.

Input: The input is the collection of stored information records, including associated information and derived features (for example, type, emotion-related attributes), and the retrieval request parameters.

Output: The output is an instruction sentence in natural language or structured text to be used as a prompt for the generative AI model.

The server uses templates and transformation rules to assemble a description of the user's past interest tendency and emotional patterns, along with explicit constraints derived from the current request, into a coherent text. For example, the server can generate a prompt sentence such as: “Generate three new article recommendations related to the user's recently saved technology and science articles with positive sentiment, and describe why each article matches the user's past interests.”

### Step 16:

The server inputs the instruction sentence to the generative AI model and obtains candidate related information.

The server tokenizes the instruction sentence according to the vocabulary of the generative AI model, feeds the token sequence into the model, and computes output token sequences that represent candidate recommendations or descriptions.

Input: The input is the instruction sentence produced by the server and the current state and parameters (weights) of the generative AI model.

Output: The output is a set of model-generated sequences that encode new related information, such as recommended content descriptions or textual explanations.

The server runs the model inference algorithm (for example, a transformer-based decoding process with attention layers) on dedicated hardware or accelerated resources, decodes the output tokens back into text, and interprets the generated text as candidate related information items.

### Step 17:

The server filters and ranks the candidate related information.

The server evaluates the generated text using similarity measures, emotional alignment checks, and constraint satisfaction tests to select and order the most appropriate recommendations.

Input: The input is the set of generated candidate sequences from the generative AI model and the stored information representing the user's history and constraints.

Output: The output is a ranked list of related information items, each associated with a score indicating relevance and suitability.

The server converts candidate texts into vector representations, compares them with embeddings of stored information, calculates similarity scores and penalty factors for violations of conditions, and then applies a ranking algorithm to produce a final ordered list.

### Step 18:

The server sends the list information and the related information recommendations to the terminal.

The server composes a response that includes both the list of stored items and the selected related information generated by the generative AI model.

Input: The input is the list information for stored items and the ranked recommendations from the filtering and ranking process.

Output: The output is a response message transmitted to the terminal that contains data for rendering saved items and new related information.

The server formats the response in a structured representation, associates each recommendation with necessary metadata for display (for example, titles or short descriptions), and sends the response over the communication network.

### Step 19:

The terminal renders the saved items and related information for the user.

The terminal parses the response, constructs UI components for each saved item and each recommended item, and displays them on the screen in a list or grid layout.

Input: The input is the response message from the server containing structured list information and recommendation data.

Output: The output is a visual presentation on the terminal that shows the user's stored electronic information and the newly generated related information.

The terminal binds data fields such as title, thumbnail, and explanation text to UI elements, triggers asynchronous loading of any referenced images, and provides interaction controls so that the user can select either saved items or recommended items for further viewing.

### Step 20:

The user interacts with saved items and recommendations on the terminal.

The user selects one of the displayed items, causing the terminal to open the corresponding electronic information or to request additional details from the server.

Input: The input is user interaction events, such as taps or clicks on specific displayed items.

Output: The output is either a new content display on the terminal or a follow-up request to the server for more detailed information.

The terminal interprets the selected item's reference information, opens a viewer or browser to display the associated content, and, if necessary, sends another request to the server to retrieve underlying content data or extended metadata based on the reference stored in the system.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information recommendation systems typically rely on fixed-rule filtering or simple statistical models that retrieve content based primarily on keyword matching and coarse user preference tags. In such systems, a processor generally responds to a user's search query by executing straightforward database lookups over stored content indices, and then returning results sorted by basic relevance scores such as term frequency or recency. This architecture suffers from several technical limitations in terms of how user interaction data is represented, how recommendation logic is executed, and how external generative models are integrated.

First, existing systems often store user interaction data, such as “likes” or bookmarks, as loosely structured records that are weakly indexed and not normalized into a coherent user interest profile. As a result, when the processor needs to generate recommendations, it must execute multiple ad hoc queries over fragmented data structures, causing increased input/output operations, inefficient memory usage, and latency in generating personalized results. These systems do not systematically transform user behavior and content metadata into structured, machine-usable profile data that can be exploited by advanced models.

Second, in conventional architectures, integration with a generative AI model, if used at all, is typically shallow and task-specific. For example, a generative model may be invoked only to rewrite summaries or provide generic content suggestions without a precise and reproducible prompt construction mechanism based on internal user data structures. The lack of a defined, data-driven prompt generation pipeline prevents the system from leveraging the full expressive power of the generative AI model and leads to inconsistent, noisy, or irrelevant outputs, thereby degrading the technical effectiveness of recommendation modules.

Third, user search behavior, click behavior, and subsequent reactions to recommendations are often logged in separate subsystems without unified feedback into the recommendation engine. This fragmentation prevents iterative refinement of the underlying data representations and model inputs. The processor is not configured to treat behavior logs as training-like signals for updating a structured interest profile and adjusting how prompts are constructed for the generative AI model. Consequently, the system cannot adapt effectively to changes in user interests over time, resulting in stale recommendations and unnecessary computational work on content that is no longer relevant.

Fourth, typical interfaces between a recommendation server and user devices are designed merely for content display, rather than being tightly coupled to the data structures and model-driving logic on the server side. The server thus cannot efficiently generate and deliver combined display data that includes both retrieved items and AI-generated recommendations in a unified, structured form. This leads to fragmented rendering workflows on the client device, redundant network transfers, and complexity in coordinating updates between stored user data and visible recommendations.

Accordingly, there is a need for an improved computer-implemented system and method that: (i) captures user interest-indicating operations and content metadata as structured data with consistent indexing; (ii) generates a machine-usable user interest profile from search histories, reference histories, and interaction logs; (iii) automatically constructs and updates a prompt sentence tailored to a generative AI model using this interest profile and current search context; (iv) parses and enriches the generative model's output into structured recommendation objects; and (v) feeds back subsequent user interactions on those recommendations into the interest profile and prompt generation process. Such a system would improve the operation of the computer itself by reducing redundant queries, standardizing data representations, increasing the relevance and stability of recommendation results, and enabling more efficient utilization of network and processing resources when orchestrating recommendations with a generative AI model.

The specific processing by the specific processing unit 290 of the data processing device 12 in Application Example 1 is realized by the following means.

The present invention provides a server comprising a processor and a storage device, the processor being configured to detect, via communication with an information processing terminal, an operation in which a user indicates interest in a presented information resource, to acquire attribute information including identification information, reference information, classification information, and time information corresponding to the information resource and to generate such attribute information as structured data indexed by a user identifier in the storage device; to respond to a user search request by parsing character string information constituting the search request and extracting from the storage device structured data of information resources corresponding to the user identifier and the parsed character string information; to generate interest profile data that represents at least a user's fields of interest and usage tendencies based on structured data recorded in the storage device and based on search history information and reference history information collected from the user; to automatically construct a prompt sentence, in a machine-usable natural language format, as request data for a generative artificial intelligence model, the prompt sentence including the interest profile data and context information representing a current search situation and specifying constraints such as a number of recommendation items, summary lengths, and types of information sources; to transmit the prompt sentence to the generative artificial intelligence model, to receive recommendation information output by the generative artificial intelligence model in response to the prompt sentence, and to parse the recommendation information into structured recommendation information objects that each include at least title information, summary information, and candidate source information; to optionally transmit a search request to an external information providing apparatus for each recommendation information object, to acquire location information of corresponding actual information resources, and to associate the location information with the recommendation information objects so as to generate recommendation result data that are presentable to the user; to integrate the structured data of information resources extracted based on the user search request with the recommendation result data into unified display data, and to transmit the unified display data to the information processing terminal for presentation through a user interface that enables the user to re-access stored information resources and discover new information resources; and to record, as behavior history information in the storage device, operation content and structured data of target information resources when the user performs a new interest-indicating operation or a reference operation on an information resource included in the recommendation result data, and to update the interest profile data and subsequent prompt sentences based on the behavior history information. This enables technical improvement of the computer-implemented recommendation process by standardizing user interaction data into structured profiles, by generating and iteratively refining model-specific prompt sentences that drive a generative AI model, by converting model outputs into enriched, link-resolved recommendation objects, and by closing a feedback loop in which subsequent user behavior automatically adjusts stored profiles and prompt construction logic, thereby enhancing relevance, reducing redundant computation, and improving overall system efficiency in delivering personalized information resources.

The term “processor” refers to one or more hardware computation units, such as central processing units or dedicated logic circuits, configured to execute instructions and perform operations defined by program code.

The term “storage device” refers to one or more hardware or virtual components capable of non-transitory recording and retrieval of digital data, including but not limited to semiconductor memory, magnetic storage, optical storage, or network-accessible storage resources.

The term “information processing terminal” refers to an electronic apparatus operated by a user, such as a mobile device, a tablet device, a notebook device, or a desktop device, that communicates with the server to display information resources and to accept user operations.

The term “user” refers to an individual or entity that interacts with the information processing terminal and the server in order to view, search, or manage information resources.

The term “information resource” refers to a unit of digital content that is accessible or retrievable via a communication network and that may be represented by text data, image data, audio data, video data, or a combination thereof.

The term “operation indicating interest” refers to a user action performed via the information processing terminal, such as selecting a control element, actuating a button, or performing a gesture, that explicitly or implicitly expresses that the user has interest in a presented information resource.

The term “attribute information” refers to data describing properties of an information resource, including but not limited to identification information, reference information, classification information, and time information related to the information resource.

The term “identification information” refers to data that uniquely or semi-uniquely distinguishes an information resource from other information resources, such as an identifier, a uniform resource identifier, or a content hash.

The term “reference information” refers to data enabling access to an information resource, such as a network location, a uniform resource locator, an access path, or other addressing data.

The term “classification information” refers to data representing a categorization or labeling of an information resource, such as topic categories, tags, genres, or other taxonomic indicators.

The term “time information” refers to data representing a temporal aspect associated with an information resource or a user operation, such as a creation time, an update time, or a time of user interaction.

The term “structured data” refers to digital data organized according to a predefined schema or format, such as records, fields, and keys, enabling indexed storage, efficient retrieval, and programmatic manipulation.

The term “user identifier” refers to a data element or set of data elements that associates stored data with a particular user, such as an account identifier, an authentication token, or another unique user reference.

The term “search request” refers to a query issued by a user via the information processing terminal, including character string information or other parameters specifying criteria for retrieval of information resources.

The term “character string information” refers to a sequence of characters, such as letters, digits, and symbols, that expresses a search term, keyword group, or other textual input used to filter or locate information resources.

The term “search history information” refers to data representing past search requests submitted by a user, including search terms, timestamps, and optionally contextual parameters associated with those search requests.

The term “reference history information” refers to data representing information resources that have been accessed, viewed, or otherwise utilized by a user, including identifiers, timestamps, and access context.

The term “interest profile data” refers to data derived from structured data, search history information, and reference history information, representing inferred user fields of interest, usage tendencies, or preference patterns.

The term “usage tendencies” refers to patterns or statistical characteristics of user behavior, including frequency of access to certain categories, typical interaction sequences, or temporal trends in content consumption.

The term “context information” refers to data representing a current situation related to a search or interaction, such as the current search request, recent operations, device state, or temporal and environmental conditions that may influence recommendations.

The term “generative artificial intelligence model” refers to a computational model, typically implemented as a neural network or similar machine learning system, that is trained on data and configured to generate new content or responses, such as text, code, or media, in accordance with an input condition.

The term “prompt sentence” refers to a natural-language or structured instruction input to a generative artificial intelligence model, specifying a task, constraints, and contextual information so as to guide the generation of output content.

The term “request data” refers to a data structure transmitted from the server to the generative artificial intelligence model or to an external information providing apparatus, including parameters, prompt sentences, and other control information necessary to obtain a response.

The term “recommendation information” refers to data output from a generative artificial intelligence model or another recommendation mechanism, suggesting one or more information resources or categories that may be relevant to a user.

The term “recommendation information object” refers to a structured representation of recommendation information, including at least title information, summary information, and candidate source information associated with a recommended information resource.

The term “title information” refers to data that concisely names or labels a recommended information resource, enabling a user to recognize the main subject or content.

The term “summary information” refers to data that briefly describes the content of a recommended information resource, typically in one or more sentences, allowing the user to understand the gist of the resource.

The term “candidate source information” refers to data indicating potential origins or providers of a recommended information resource, such as domain names, source categories, or descriptive labels of content providers.

The term “external information providing apparatus” refers to a remote system accessible via a communication network, such as a search service, a content distribution service, or another server, that can return information resources or metadata in response to a query.

The term “location information” refers to data that indicates where an information resource can be accessed, such as a network address, a uniform resource locator, or another access descriptor.

The term “recommendation result data” refers to structured data that combine recommendation information objects with associated location information and other presentation parameters, in a form suitable for display to a user.

The term “display data” refers to data prepared for presentation on an information processing terminal, comprising layout, ordering, and content representations for information resources and recommendation result data.

The term “user interface” refers to a set of interactive elements and display components presented on the information processing terminal, through which the user can view information resources, input operations, and interact with recommendation results.

The term “behavior history information” refers to data representing past operations performed by a user on information resources or recommendation results, including interest-indicating operations, reference operations, and associated timestamps and target identifiers.

The term “learning data” refers to data used to update or refine interest profile data and prompt sentence generation logic, including behavior history information and any derived features or statistics.

The term “interest-indicating operation” refers to a subset of user operations that express a positive or negative preference regarding an information resource, such as a selection, a rating, or a bookmarking action.

The term “reference operation” refers to a user action that causes an information resource to be accessed or displayed, such as opening, playing, or expanding the information resource on the information processing terminal.

In one embodiment, a server cooperates with one or more terminals and a communication network to implement the claimed system. The server comprises at least one processor, a main memory, a non-transitory storage device, and a network interface. The terminal comprises at least one processor, a memory, a display unit, an input unit such as a touch panel, and a network interface. The user operates the terminal to view digital information resources, indicate interest in particular information resources, and receive recommended information resources.

The server executes server-side application software, including a web service framework, a storage management module, an interest profiling module, a prompt generation module, a generative AI interaction module, a recommendation enrichment module, and a behavior logging module. The terminal executes client-side application software, such as an application built with a cross-platform user interface framework, which presents list screens, detail screens, and interactive controls to the user.

The server stores structured data and user-related logs in a database system implemented on the storage device. In one example, the server uses a document-oriented database that stores records as documents composed of key-value pairs. The server defines a data schema including at least the following logical collections: a user collection storing user identifiers and basic attributes; a flag collection storing structured data corresponding to user interest-indicating operations; a search history collection storing past search requests; a click history collection storing access events for information resources; and a recommendation log collection storing prompt sentences and model outputs associated with recommendation events.

The server configures each record in the flag collection as a structured object including fields such as a user identifier, an information resource identifier, reference information representing a network location of the resource, classification information representing a category, topic, or tag, and time information representing the moment of the interest-indicating operation. The server also includes optional fields such as a confidence score, language code, and media type. By storing such data in a normalized, indexed form, the server enables efficient query operations using composite indexes on the user identifier and classification information, thereby reducing search latency and disk I/O compared to unstructured logs.

The terminal displays a list of information resources using the display unit. The terminal renders each list item with a title, a thumbnail image when available, and an interactive control such as a “save” or “like” button. When the user taps the button, the terminal captures the event via an input event handler and generates a metadata payload including at least the resource identifier, title text, network address, and local timestamp. The terminal transmits this payload together with the user identifier to the server through the network interface using a secure communication protocol.

The server receives the payload and validates each field using the processor. The server checks that the user identifier corresponds to a valid user record, that each string field satisfies length constraints, and that the network address conforms to a defined format. The server then transforms the payload into a structured record according to the schema of the flag collection. The server stores this record in the database and updates any relevant indexes.

This transformation ensures that later queries for the user's interest history can be performed by index lookups rather than full scans, improving computational efficiency and reducing response time.

The server collects search history information and reference history information in a similar manner. When the user inputs a search query on the terminal, the terminal transmits a search request including the query string, user identifier, and optional context attributes such as language and device type. The server parses the query string into tokens using a tokenizer that performs lowercasing, punctuation removal, and, in some embodiments, stemming or lemmatization. The server stores the raw query string and the processed tokens in the search history collection along with the user identifier and time information.

When the user opens an information resource, the terminal sends an access event to the server. The server records this event in the click history collection, including the user identifier, resource identifier, access time, and the source context such as “search result,” “library,” or “recommendation.” This consistent logging structure enables the server to compute usage tendencies and temporal patterns over these collections using simple aggregation queries.

The server generates interest profile data as a higher-level data structure synthesizing data from the flag collection, search history collection, and click history collection. The server configures the interest profiling module to periodically or on-demand retrieve all records associated with a given user identifier and to compute statistics such as: the frequency of access to each classification category; the recency-weighted score for each topic; the distribution of media types consumed; and correlations between query tokens and clicked resources. The server can store the resulting interest profile as a compact vector representation, such as a sparse vector over category identifiers and tokens, or as a small JSON-like structure with fields representing “topCategories,” “recentTitles,” “recentQueries,” and “mediaPreferences.”

The server uses these structured interest profiles to reduce computational overhead in future recommendation rounds. Rather than re-querying entire log collections for each recommendation, the server can directly read a precomputed profile and use it as a basis for subsequent prompt generation. This design improves processing speed and reduces load on the database subsystem, thereby constituting a technical improvement to the overall computer system.

The server implements the generative AI interaction module as a software component that communicates with a remote or local generative AI model over a programmatic interface. In one embodiment, the generative AI model is a transformer-based neural network having multiple attention layers, feedforward layers, and embedding layers. The model parameters are stored on a separate computing infrastructure, such as a group of graphics processing units or specialized accelerators. The model is trained using supervised or self-supervised learning on large-scale corpora, with an objective function such as cross-entropy loss applied to token prediction. During training, the model adjusts its weight matrices by backpropagation and gradient-based optimization (e.g., stochastic gradient descent with adaptive learning rates), thereby learning statistical relationships between sequences of tokens.

The server does not retrain the generative AI model during normal recommendation operations, but the server controls the model's behavior by constructing and supplying a carefully structured prompt sentence. The server executes specific algorithms for prompt generation that are not merely human-like description, but are constrained by data structures and rules that encode the interest profile. For example, the server may select the top N categories by score from the interest profile, then select representative recent titles, and select the M most frequent search tokens over a defined time window. The server then maps these elements into a natural-language template according to a deterministic rule set.

In one example, the server generates a prompt sentence of the following form:

“Based on the following user interest profile:
Top categories: [Category A], [Category B], [Category C].
Recently saved items: [Title 1], [Title 2], [Title 3].
Recent search queries: [Query 1], [Query 2].

Recommend 5 new and recent online articles that this user is likely to find interesting. Focus on generative AI model applications, startups, and mobile software innovation. For each recommendation, provide:
1. A concise title.
2. A two-sentence summary.
3. Suggested source domains or provider types (not exact URLs).”

The server constructs such a prompt sentence by concatenating static template fragments and dynamically selected items from the interest profile. The server applies length constraints on each inserted title or query to avoid exceeding model input limits. By strictly controlling the structure of the prompt and embedding an explicit specification of output format and constraints, the server improves the consistency and machine-parsability of the model's response. This disciplined prompt construction is a non-conventional data processing step that directly enhances the ability of the computer system to obtain predictable, structured outputs from a generative AI model.

The server transmits the prompt sentence to the generative AI model together with control parameters such as maximum output length, randomness temperature, and nucleus sampling threshold. The model processes the input by computing token embeddings for the prompt, performing successive self-attention and feedforward operations over multiple layers, and generating a sequence of tokens representing recommended titles, summaries, and candidate sources. The model's internal operations are mathematical matrix multiplications, vector additions, and nonlinear activations, which the hardware accelerators execute in parallel, providing rapid inference that would not be feasible by manual human reasoning in a similar time frame.

The server receives the raw text output and processes it using the recommendation enrichment module. The server applies a parser that identifies numbered items or delimiter phrases, splits the output into segments, and extracts candidate title lines and summary lines. The server may apply heuristic rules or regular expressions to normalize whitespace, remove extraneous commentary, and map each segment to fields of a recommendation information object. In some embodiments, the server enforces validation rules such as maximum title length or minimum summary length to ensure display suitability.

The server enriches each recommendation information object by optionally communicating with an external information providing apparatus, such as a search service or content provider. The server generates a search query derived from the title and candidate source information, and transmits it to the external apparatus. The external apparatus returns search results containing actual network locations and metadata. The server selects one or more high-ranking results, for example by evaluating domain reputation, recency, or keyword overlap, and assigns the corresponding location information and thumbnail reference to the recommendation information object. By performing this mapping, the server connects abstract recommendations from the generative AI model to concrete, accessible information resources.

The server then generates recommendation result data as a structured aggregation of recommendation information objects. The server combines these data with structured data for resources retrieved from the database in response to the user's initial search query. The server orders the combined results according to a defined ranking algorithm that can prioritize direct matches, generative recommendations, or recency, depending on configuration. The server constructs a display data object including visual attributes such as section headers, item ordering, and layout hints.

The terminal receives the display data and renders the information resources and recommendation result data on the display unit. The terminal uses its processor and graphics capability to render lists and details, reducing the processing required on the server for layout.

The user can scroll through the lists, open items, and trigger further interest-indicating operations. Each such operation produces additional structured events that the terminal transmits to the server. This closed-loop interaction continually updates the interest profile using actual behavior on recommended items, not just on search results or manually curated content.

The system yields technical effects that go beyond mere automation of manual recommendation. By maintaining structured, indexed logs and computed interest profiles, the server reduces the number of full-table scans and ad hoc joins needed to generate recommendations, leading to faster response times and lower CPU and I/O usage. By using a disciplined prompt generation algorithm that encodes a structured interest profile, the server steers the generative AI model to produce outputs with stable format and higher semantic alignment with user preferences, thereby increasing the accuracy and usefulness of recommendations. By parsing and enriching the generative outputs into structured recommendation information objects and mapping them to concrete locations via an external apparatus, the server realizes a pipeline that converts large-scale probabilistic text generation into actionable, link-resolved data that improves the effectiveness of the computer system as an information retrieval and delivery platform.

The server's feedback mechanism, in which behavior history information from recommendation interactions feeds into future interest profiles and prompt sentences, further improves technical performance. As the interest profile becomes more representative of the user's evolving behavior, the number of irrelevant recommendations and unnecessary external search requests decreases. This reduction lowers network traffic, computation for external queries, and processing in the enrichment module, thereby lowering overall resource consumption. This adaptive behavior is achieved by algorithmically updating profile vectors or profile structures using new interaction data and by explicitly modifying the parameters or contents of subsequent prompt sentences, not by mere human adjustment.

In an alternative embodiment, the server implements the database as a relational database management system and stores structured data in normalized tables rather than documents. In another embodiment, the server employs a local generative AI model hosted on the same computing infrastructure, with a smaller parameter size but reduced latency, suitable for environments with strict data privacy or network constraints. In yet another embodiment, the terminal performs part of the interest profiling computation locally, and transmits compressed feature vectors to the server instead of detailed logs, reducing network bandwidth consumption while maintaining the ability to construct effective prompt sentences.

The described system architecture, including specific data structures for flags, histories, and profiles, specific algorithms for prompt construction and model output parsing, and explicit integration of external information providing apparatus, constitutes a particular machine implementation that improves the functioning of the computer itself as a recommendation engine. The server, terminal, and model cooperate to perform non-conventional data processing and communication flows that yield improvements in speed, relevance, structure, and efficiency of information recommendation beyond what is achievable by human operators or simple rule-based filtering systems.

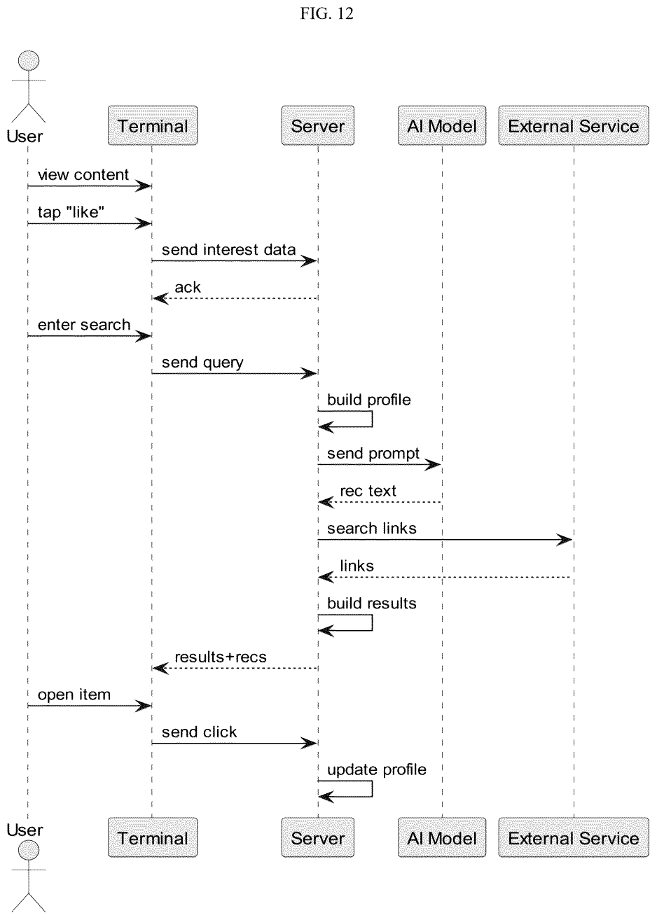

The following describes the processing flow using FIG. 12.

### Step 1:

The user operates the terminal to indicate interest in an information resource.

The terminal displays a list or detail view of information resources including titles, thumbnails, and an interest-indicating control such as a “like” or “save” button. The user taps the control for a particular item. The input to this step is a user touch event associated with a specific resource identifier. The terminal processes this event by reading the resource identifier, title text, network address, category label, media type, and the current local time, and then assembling these values into a metadata object. The output of this step is a structured metadata payload containing at least the user identifier, resource identifier, reference information, classification information, media type, and timestamp.

### Step 2:

The terminal transmits the interest metadata to the server.

The terminal receives the structured metadata payload from Step 1 and adds communication headers such as authentication tokens and protocol version information. The input to this step is the metadata payload and the current network configuration. The terminal serializes the metadata into a format such as JSON, opens a secure network connection to the server, and sends the serialized data as the body of a request. The terminal may perform simple compression or batching if multiple interest events are pending. The output of this step is a network message delivered to the server containing the interest-indicating metadata.

### Step 3:

The server validates and stores the interest metadata as structured data.

The server receives the network message from the terminal and parses the serialized body into an internal data structure. The input to this step is the raw request containing the metadata payload. The server authenticates the user by verifying the token, checks that all mandatory fields (user identifier, resource identifier, reference information, timestamp) are present, and enforces constraints such as maximum string lengths and valid URL formats.

The server then transforms the parsed data into a normalized record conforming to the schema of a flag or interaction collection and assigns a document key or primary key. The server writes this record into the storage device and updates indexes on the user identifier and classification information. The output of this step is a stored structured record accessible by indexed queries and a status response to the terminal indicating successful registration.

### Step 4:

The user performs a search using the terminal.

The terminal presents a search input field and optional filters such as category or media type selectors. The user enters a free-form text query and optionally adjusts filters. The input to this step is the user's keystrokes and selection actions on the terminal. The terminal aggregates the search text, selected filters, user identifier, and current time into a search request object. The terminal may normalize whitespace and trim leading or trailing spaces.

The output of this step is a structured search request ready to be sent to the server.

### Step 5:

The terminal transmits the search request to the server.

The terminal takes the search request object from Step 4 and attaches necessary headers including user authentication information. The input to this step is the structured search request object. The terminal serializes the request, opens a secure network connection, and sends the serialized data to a search endpoint on the server. The terminal may start a local loading indicator while waiting. The output of this step is a network message that delivers the search query and context to the server.

### Step 6:

The server parses the search request and retrieves matching stored information resources.

The server receives the search request and parses the serialized body to extract the query string, filters, user identifier, and timestamp. The input to this step is the structured search request from the terminal. The server passes the query string through a tokenizer that lowercases characters, removes punctuation, optionally performs stemming, and discards stop words, producing a set of query tokens. Using these tokens and filters, the server constructs one or more indexed queries against the storage device, restricted to records associated with the user identifier. The server executes these queries to retrieve records whose titles, categories, or tags match the tokens, and sorts the results by relevance or recency. The output of this step is a list of structured records representing stored information resources that are relevant to the search.

### Step 7:

The server updates search history information and click context for profiling.

The server uses the parsed search request to record a search history entry. The input to this step is the search request data and the list of matched records from Step 6. The server creates a new history record including the user identifier, raw query string, processed tokens, filters, and time information. The server stores this record in a dedicated search history collection and may attach a reference to the matching resource identifiers for later analysis. This storage operation converts ephemeral search operations into persistent structured data. The output of this step is a new search history entry that can later be aggregated into interest profile data.

### Step 8:

The server computes or refreshes interest profile data for the user.

The server takes as input the stored structured records from the flag collection, the search history entries, and any reference or click history entries associated with the user identifier.

The server executes aggregation queries that count occurrences of classification categories, compute recency-weighted scores using time decay functions, and tally token frequencies in titles and queries. The server then converts these counts into normalized scores, for example by dividing by total interactions or applying softmax-like scaling. The server assembles these values into a compact interest profile object that includes ranked categories, a list of recent titles, a list of recent queries, and media type preferences. The output of this step is the updated interest profile data, stored in the storage device and also held in memory for immediate use.

### Step 9:

The server generates a prompt sentence for the generative AI model based on the interest profile and current search context.

The server uses the interest profile from Step 8 and the current search request from Step 6 as input. The server selects the top categories by score, selects a limited number of recent titles, and selects the most recent or frequent search queries. The server then inserts these selected items into a predefined natural-language template, enforcing maximum string lengths and ensuring that the total token count remains within model limits. For example, the server may generate the following prompt sentence:

“Based on the following user interest profile:
Top categories: artificial intelligence, mobile software, startup technology.
Recently saved items: ‘Breakthrough in Generative AI for Mobile Applications’, ‘Funding Trends for AI-Based Startups’.
Recent search queries: ‘AI startup funding’, ‘mobile AI tools’.

Recommend 5 new and recent online articles that this user is likely to find interesting. Focus on generative AI model applications, startup ecosystems, and mobile software innovation.

For each recommendation, provide:
1. A concise title.
2. A two-sentence summary.
3. Suggested source domains or provider types (not exact URLs).”

The server concatenates these lines into a single prompt sentence or multi-paragraph text. The output of this step is a prompt sentence that encodes structured user interests and constraints in a machine-usable natural-language form.

### Step 10:

The server sends the prompt sentence to the generative AI model and obtains recommendation text.

The server uses the prompt sentence from Step 9 and model control parameters as input. The server prepares a model request including the prompt sentence, maximum output length, randomness temperature, and sampling parameters. The server transmits this request over a network interface to a computing system hosting the generative AI model. The generative AI model processes the prompt using its internal neural network computations to generate a sequence of output tokens representing recommended titles, summaries, and source hints. The model returns this sequence to the server as a text response. The output of this step is raw recommendation text produced by the generative AI model in response to the prompt sentence.

### Step 11:

The server parses the recommendation text into structured recommendation information objects.

The server receives the raw recommendation text as input. The server applies parsing logic that detects item separators such as numbered lines or bullet markers, splits the text into segments for each recommended item, and identifies a title line, summary lines, and source indicator text for each segment. The server may apply simple pattern matching and length checks to assign each line to an appropriate field. The server then constructs a recommendation information object for each item, containing at least title information, summary information, and candidate source information. The output of this step is a list of structured recommendation information objects representing the generative AI model's suggestions.

### Step 12:

The server enriches recommendation information objects with concrete location information.

The server uses each recommendation information object from Step 11 as input. For each object, the server composes an external query by combining the title, selected keywords from the summary, and candidate source information. The server sends this query to an external information providing apparatus, such as a search or content service. The external apparatus returns search results including network addresses and metadata. The server evaluates these results by computing a relevance score based on text similarity and domain reliability, and selects a result above a threshold. The server then adds the selected network address and any thumbnail reference to the corresponding recommendation information object. The output of this step is an enriched list of recommendation information objects, each associated with actual location information for an information resource.

### Step 13:

The server combines retrieved stored resources and enriched recommendations into unified display data.

The server takes as input the list of stored resources matched to the user's search from Step 6 and the enriched recommendation information objects from Step 12. The server applies a ranking or grouping algorithm that places stored matches in one section (for example, “Your Library” or “Saved Items”) and recommendations in another section (for example, “Recommended for You”). The server generates a unified display data structure containing both lists, including layout hints such as section labels and display order. The server may limit the number of items in each section to control payload size. The output of this step is unified display data ready to be delivered to the terminal.

### Step 14:

The server transmits the unified display data to the terminal.

The server receives the unified display data from Step 13 as input. The server serializes this data into a compact format and sends it through the network interface as a response to the search request. The server may apply compression to reduce bandwidth usage. The output of this step is a network response message containing all data required for the terminal to render search results and AI-based recommendations.

### Step 15:

The terminal renders the unified display data and presents it to the user.

The terminal receives the network response from the server and parses the unified display data into internal structures representing sections and items. The input to this step is the serialized display data from Step 14. The terminal uses its processor and graphics subsystem to render list views on the display, showing stored resources and recommendations, along with titles, summaries, and thumbnails. The terminal may implement lazy loading or virtualization to render only visible items and thereby conserve memory and processing power. The output of this step is a visual user interface through which the user can browse, scroll, and select information resources and recommendations.

### Step 16:

The user interacts with displayed recommendations and stored resources.

The user views the presented lists and taps on items to open them or to indicate further interest. The input to this step is the rendered user interface from Step 15. When the user taps a recommended item, the terminal records a click event including the item identifier, section type, and timestamp. When the user taps an interest-indicating button on a recommended item, the terminal generates a new interest metadata payload similar to that in Step 1. The terminal then transmits these events to the server. The output of this step is additional structured events that represent user behavior on recommended and stored content.

### Step 17:

The server records behavior history information and updates interest profiles and future prompt sentences.

The server receives behavior events from the terminal, including click and new interest-indicating operations, as input. The server parses and validates each event, and stores them as new records in click history and flag collections. The server then recomputes or incrementally updates the interest profile data for the user by adjusting category scores, updating lists of recent titles and queries, and revising media type preferences according to the new events.

The server also stores summary statistics or feature vectors that will be used when generating the next prompt sentence. The output of this step is an updated interest profile and an internal state of the system that will cause subsequent prompt sentences and generative AI model calls to better reflect the user's evolving preferences.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information retrieval systems running on general-purpose computing devices typically treat user search queries and user preference data as separate, weakly connected streams of information. A server may store bookmarks, histories, or simple “favorite” marks, and may also respond to keyword-based search queries, but such systems generally fail to exploit structured, machine-processable representations of a user's past interest behavior and emotional context in order to improve retrieval quality. As a result, when a user attempts to re-find or build upon information that was previously of interest, the system often returns undifferentiated search results that do not prioritize items the user has explicitly indicated as important, and that do not integrate newly recommended content in a coherent, context-aware manner.

Furthermore, even when a server stores metadata associated with digital content, existing systems usually do not convert this metadata into a form that can be systematically combined with user-centric signals (such as interest indicators and emotional state indicators) and then fed, in a structured way, to a generative artificial intelligence model. In many implementations, a generative artificial intelligence model is invoked with ad hoc or manually crafted prompt sentences that do not consistently reflect the user's prior interactions, leading to unstable or suboptimal recommendations. This lack of tight integration between storage-level indexing, query-time filtering based on explicit interest indicators, and prompt-level conditioning for a generative artificial intelligence model results in inefficient use of computing resources and degraded user experience.

Additionally, existing architectures frequently require separate application logic for retrieving stored content, ranking that content, and formulating prompts to external intelligent services.

Such fragmented architectures increase processing latency, complicate error handling, and reduce scalability, particularly when the system must handle many concurrent users and large volumes of user-specific interest data. In other words, the underlying computer technology namely, the way in which processors, storage devices, and networked components cooperate to retrieve and recommend information is not optimized to leverage user interest indicators and emotional context as first-class, machine-usable primitives within a unified retrieval and recommendation pipeline.

Accordingly, there is a need for an improved computer-implemented technique that allows a processor to (i) detect and store user interest indicators in association with detailed metadata of information resources in a storage device, (ii) efficiently filter and retrieve such interest-indicated resources in response to a user's search query, and (iii) systematically construct and supply structured prompt sentences to a generative artificial intelligence model so that the model can generate new, contextually relevant recommendation information. Such a technique should provide a concrete improvement to the functioning of the computer system itself, by reorganizing how data is captured, indexed, and processed, and by reducing the computational overhead and user interaction steps required to obtain personalized, high-quality results.

The specific processing by the specific processing unit 290 of the data processing device 12 in Example 2 is realized by the following means.

The present invention provides a server comprising a processor configured to detect, via a terminal operated by a user, an operation for assigning an interest indicator to an information resource in which the user has interest, acquire attribute information related to the information resource, convert the attribute information into machine-readable data, and store the machine-readable data in a storage device in association with the interest indicator; to receive, via a communication interface, request data including a character-string search query and user identification information input by the user through the terminal, analyze the character-string search query to generate a search condition, and extract, from the storage device, one or more related information resources based on the interest indicator and the search condition; to generate, based on information relating to the extracted information resources and a past interest history of the user, a structured prompt sentence for causing a generative artificial intelligence model to recommend related new information, instruct that the structured prompt sentence be supplied to the generative artificial intelligence model, and obtain response information generated by the generative artificial intelligence model; and to transmit, to the terminal, the information relating to the extracted information resources and the response information obtained from the generative artificial intelligence model, and cause the terminal to output the information as search results formatted in a presentation format for the user. This enables an improvement in computer technology by allowing the server to utilize explicitly stored user interest indicators and associated metadata to perform more efficient, context-aware retrieval in the storage device, to automatically construct machine-targeted prompt sentences that condition the generative artificial intelligence model on structured past-interest data, and to reduce processing redundancy and user interaction steps, thereby enhancing the overall performance, scalability, and personalization quality of the information retrieval and recommendation operations executed by the computer system.

The term “system” refers to a combination of one or more computing devices, communication components, and storage components that cooperate to perform information retrieval and recommendation processing as described in the claims.

The term “processor” refers to a hardware processing unit, such as a central processing unit or other computing circuitry, configured to execute instructions to perform the detection, analysis, generation, and transmission operations described in the claims.

The term “terminal” refers to an electronic computing device, such as a general-purpose computer, a portable computing device, or any other user-facing interface device, through which a user can input information and receive information from the system.

The term “user” refers to a person or an entity that operates the terminal and interacts with the system by providing input and receiving output.

The term “information resource” refers to any digital content item, including but not limited to text data, image data, audio data, video data, or combinations thereof, that can be stored, retrieved, and processed by the system.

The term “interest indicator” refers to data indicating that a user has expressed interest in an information resource, such as a flag, rating, tag, score, or other machine-readable signal associated with the information resource.

The term “operation for assigning an interest indicator” refers to an input action performed by the user via the terminal, such as selecting, clicking, tapping, or otherwise designating an information resource, that causes the system to associate an interest indicator with that information resource.

The term “attribute information” refers to metadata or descriptive data associated with an information resource, including, for example, a title, description, creation time, identifier, content type, keyword, or other characteristic that can be used by the system for indexing and retrieval.

The term “machine-readable data” refers to data encoded in a format that can be processed by the processor and stored in the storage device without human interpretation, such as structured records, key-value pairs, or serialized data formats.

The term “storage device” refers to a hardware or virtual storage component, such as a memory, a magnetic storage device, a solid-state storage device, or a distributed storage system, that is capable of storing machine-readable data associated with information resources and user interest indicators.

The term “communication path” refers to any wired or wireless communication channel, network, or interface that allows data to be transmitted between the terminal and the server, including local networks and wide-area networks.

The term “communication interface” refers to hardware and software components that enable the processor to send and receive data over the communication path, such as network interface controllers, communication modules, and protocol stacks.

The term “request data” refers to data transmitted from the terminal to the server and including at least a character-string search query and user identification information.

The term “character-string search query” refers to a sequence of characters input by the user via the terminal to specify search conditions for retrieving information resources from the storage device.

The term “user identification information” refers to data that identifies or associates the user with stored information resources and interest indicators, such as a user identifier, account identifier, session identifier, or other equivalent identifier.

The term “search condition” refers to one or more machine-usable criteria, derived from the character-string search query, that are used by the processor to select relevant information resources from the storage device.

The term “extract” refers to the operation of retrieving, selecting, or obtaining one or more information resources from the storage device based on specified conditions.

The term “past interest history” refers to a collection of records or data representing previous instances in which the user assigned interest indicators to information resources, including associated metadata and contextual information.

The term “generative artificial intelligence model” refers to a machine learning model configured to generate new content, such as text or other data, in response to input data or prompt sentences, based on patterns learned from training data.

The term “prompt sentence” refers to a machine-readable textual input constructed by the processor and supplied to the generative artificial intelligence model to instruct or guide the model in generating recommendation information or other output.

The term “structured prompt sentence” refers to a prompt sentence that is organized according to a predefined format or schema, and that includes specific fields or components such as user query data, summary information of extracted resources, and user-related indicator information.

The term “response information” refers to output data generated by the generative artificial intelligence model in response to a prompt sentence, including recommendation information, summary information, or other generated content.

The term “search results” refers to information presented to the user via the terminal and including at least the information resources extracted from the storage device and, in some embodiments, the response information generated by the generative artificial intelligence model.

The term “presentation format” refers to a layout, structure, or representation of information suitable for display on the terminal, including, for example, lists, summaries, or other user interface elements.

The term “summary information” refers to condensed descriptive data about an information resource or a set of information resources, such as titles, short descriptions, or key points derived from the resources.

The term “indicator information” refers to data that represents a state or characteristic associated with the user, such as an emotional state, preference level, or other contextual attribute used to personalize recommendations.

The term “past emotional state” refers to an estimated or recorded affective condition of the user at one or more prior times, which may be represented by scores, labels, or other machine-readable forms.

The term “preference” refers to a tendency or inclination of the user toward particular types of information resources, topics, or content characteristics, as inferred or derived from the user's interest indicators and behavior.

The term “processing steps” refers to individual stages of computation carried out by the processor, including detection, analysis, generation, retrieval, and transmission operations that collectively implement the claimed functionality.

The term “integrated results” refers to combined output information that includes both information resources to which the user has assigned an interest indicator and related information recommended by the generative artificial intelligence model.

In one embodiment, a server cooperates with a terminal operated by a user to implement an information retrieval and recommendation system using a generative AI model.

The server includes at least one processor, a main memory, a non-volatile storage device, and a communication interface coupled via a bus. The terminal includes a processor, a display unit, an input unit, a memory, and a communication interface. The server and the terminal are connected via a wired or wireless communication network, such as a local area network or a wide area network including the Internet.

The server executes an application program on top of an operating system. The operating system can be, for example, a general-purpose server operating system. The application program can be implemented using a web application framework such as a generic server-side framework running on a general-purpose runtime environment. The server can optionally use a reverse proxy or HTTP server software to receive HTTP requests from the terminal and forward them to the application program.

The server accesses a storage device that stores user-related data, metadata of information resources, interest indicators, and logs. The storage device can be implemented by a relational database management system, a document store, or a combination thereof. The server defines data structures such as:
A user table that stores user identifiers and basic profile information.
A content table that stores identifiers of information resources, references (such as URLs or file paths), and core metadata including title, type (text, image, audio, video, or mixed), creation time, and content descriptors.
An interest table that stores associations between user identifiers and information resource identifiers, together with interest indicators such as flags, numerical scores, or categorical tags.
A query log table that stores historical search queries issued by the user and pointers to retrieved and selected information resources.
An emotional state table that stores time-stamped indicators representing estimated emotional states of the user, such as arousal and valence scores or discrete labels.

The terminal executes a client application that can be a web browser or a native application.

The terminal displays a graphical user interface including a search box, result list area, and controls (buttons, links, scrollbars). The terminal captures input from the user through the input unit, which may include a keyboard, touch panel, pointing device, microphone, or a combination of them.

The user interacts with the terminal to browse or consume information resources. The user, when finding an information resource of interest, performs an operation for assigning an interest indicator, for example, by clicking or tapping a “favorite,” “like,” or “save” control displayed near the information resource. The terminal sends a request message to the server indicating the user identifier, the identifier of the information resource, and the type or value of the interest indicator. The terminal can use a secure communication protocol (for example, HTTPS over TCP/IP) via the communication interface to transmit these data to the server.

The server receives the indication of the interest assignment and updates the interest table in the storage device. The server acquires attribute information (metadata) related to the information resource, either by reading existing metadata from the content table or by retrieving and analyzing the resource content to derive additional attributes. The server can extract, as attribute information, the title, a short summary, representative keywords, media type, time-related information, and other descriptors. The server converts these attributes into a structured, machine-readable format (for instance, normalized records with predetermined fields) and stores them in the storage device with indexes that allow efficient retrieval. The server, for example, creates text indexes on keyword fields and B-tree indexes on user identifiers and time stamps. This structured indexing improves query performance and reduces computational overhead at retrieval time.

The user later operates the terminal to perform a search. The user enters a character-string search query, such as “travel plan in Europe,” into the search box displayed on the terminal and activates a search control. The terminal validates the input, for example by trimming whitespace and checking that the query is not empty, and then constructs a request that includes the raw query string and user identification information. The terminal transmits this request to the server via the communication interface.

The server receives the search request through the communication interface and passes the request to the application program. The server performs text processing on the received query using a text-processing module. The server can convert the query string to lowercase, apply language-dependent normalization (such as stemming or lemmatization), and remove stop words. The server can then transform the normalized query into an internal search representation, such as a list of tokens with weights or a vector representation in an embedding space.

The server uses the internal search representation to query the storage device. The server, for example, executes a query that filters the interest table by the current user identifier and joins with the content table to retrieve information resources for which the user has assigned an interest indicator. The server applies matching criteria based on the normalized query terms and the indexed metadata of these information resources. The server can compute a relevance score for each candidate resource using a ranking function such as term frequency-inverse document frequency or a vector similarity measure between an embedding of the query and embeddings of the resource metadata. By combining interest indicators (which indicate explicit user preference) with semantic or keyword matching, the server can rank information resources in a way that focuses on items that are both relevant and previously flagged as important by the user.

The server then constructs a structured dataset of the most relevant information resources, including identifiers, titles, short descriptions, interest scores, and computed relevance scores.

The server can limit the number of resources to a predetermined maximum to reduce communication load and render time on the terminal. The server also accesses the query log table and the emotional state table to obtain data representing a past interest history and a past emotional state of the user. The server can select, for example, the most recent emotional state record before the current search, together with statistical summaries of past interest indicators (such as counts and average scores per topic category).

The server uses these data to construct a prompt sentence for a generative AI model. In one embodiment, the server implements a prompt-generation module that follows a predefined prompt template. The template explicitly defines segments such as: a summary of the current query, a list of extracted information resources with their titles and brief summaries, and compact features representing the user's past interest and emotional context. For example, the server can generate a prompt sentence such as:

“The user searched for ‘travel plan in Europe’. The user previously marked the following items as important: (1) ‘Backpacking in Western Europe’—a 10-day itinerary focused on budget travel; (2) ‘City Guide: Paris’-highlights of museums and cafes; (3) ‘Nightlife in Berlin’—clubs and music venues. The user's recent emotional state is relaxed and exploratory. Based on these items and the user's past interest in cultural experiences and budget-conscious trips, recommend new travel information and propose a 7-day itinerary that connects these interests and introduces additional suitable destinations.”

The server, by structuring the prompt in this manner, converts dispersed data from multiple tables (interest records, content metadata, emotional indicators) into a single, machine-consumable textual instruction with explicit fields. This structured prompt creation is a specific technical procedure that improves the behavior of the generative AI model, because the model can receive consistent, rich context about the user's history and preferences rather than ambiguous or incomplete cues.

The server interfaces with a generative AI model that can be implemented as a neural network, such as a transformer-based language model. The model includes an embedding layer that maps input tokens into high-dimensional vectors, multiple attention layers that process token interactions, and a decoding layer that outputs probability distributions over a vocabulary. The model is pre-trained on large-scale text corpora and then optionally fine-tuned using domain-specific data that includes example prompts and target responses in the context of user interest-based recommendations.

The server prepares the prompt sentence as a sequence of tokens and transmits it to the generative AI model via an inference interface. The model, given this prompt, computes internal hidden states and generates output tokens according to a decoding strategy such as beam search or nucleus sampling. The server can configure parameters such as maximum output length, temperature value for randomness, and penalty terms for repetition, to control output stability and diversity. The model uses its attention mechanism to condition the generation on the part of the prompt that describes user interest and emotional state, thereby producing recommendation information that explicitly relates to the stored interest indicators.

The server receives the generated text from the generative AI model as response information.

The server parses the generated text and, if necessary, performs post-processing such as segmenting itinerary steps, extracting recommended locations, or grouping suggested items by category. The server can also perform consistency checks by comparing recommended items against the stored content or by filtering out items that are not available in the current dataset, thus reducing errors and enhancing reliability.

The server then integrates the stored information resources and the generated recommendations. For instance, the server creates a composite result set that includes:
A prioritized list of previously stored information resources that match the current query and interest indicators.
A set of newly recommended items derived from the generative AI model's response, optionally linked to existing content if the items correspond to known resources.
A narrative summary or itinerary text that weaves together stored and new items.

The server formats this composite result set into a structured response that the terminal can easily render. The server can, for example, encapsulate titles, summaries, scores, and AI-generated text into a tree-like or list-based data structure and then transmit this structure to the terminal via the communication interface. The server can minimize data volume by excluding redundant fields, compressing text where appropriate, and only including the top-ranked items, thereby reducing communication load and improving response time.

The terminal receives the formatted response and, under control of its own processor, renders the search results as user interface elements. The terminal can display, for example, a list of user-marked resources at the top of the screen, followed by a section labeled “Recommended for you based on your past interests,” which shows items described in the generative AI model's output. The terminal can display the AI-generated itinerary as a structured timeline or as collapsible sections by day. Because the server provides well-structured data, the terminal can avoid heavy client-side computation and can simply map the received data to predefined display templates, resulting in lower terminal load and smoother interaction.

The server, in this configuration, improves computer technology in several ways. By storing interest indicators and associated metadata in indexed, normalized structures, the server reduces the number of full-scan operations in the storage device and instead performs index-based lookups, which lowers latency and CPU load. By converting a user's distributed past interactions and emotional context into a structured prompt sentence, the server enables the generative AI model to generate more precise and context-aware responses, which improves the accuracy and relevance of recommendations. This structured integration of retrieval data into prompts is different from simply automating a human's natural-language drafting of a query; it uses internal data structures, ranking scores, and user-state indicators that are not readily accessible to a human and that are optimized for machine processing.

Moreover, the server executes a non-conventional processing flow that interleaves classical database retrieval and generative modeling under a unified control logic. The server first filters and ranks stored resources according to explicit interest indicators and query relevance, then calculates compact features of the user's past interest and emotional history, and only then encodes these as part of the prompt. This sequence reduces the size of the context passed to the generative AI model and eliminates many irrelevant candidates before generation, which reduces inference time, lowers memory bandwidth usage, and decreases energy consumption in the data center. The server thereby increases overall system throughput when handling many concurrent users.

The server can, in other embodiments, adapt the internal behavior of the generative AI model by adjusting model hyperparameters in accordance with system conditions. For example, when server load is high, the server can instruct the model to use a smaller beam size or shorter maximum output length, directly reducing computation per request while still leveraging the stored interest indicators to maintain acceptable personalization quality. When more computing resources are available, the server can allow longer outputs or more complex sampling strategies for richer recommendations.

The server can train or fine-tune the generative AI model using supervised learning. The server collects training examples from historical interactions, where an input prompt is composed of a past search query, a set of interest-indicated resources, and emotional state indicators, and the target output is a human-curated or highly rated recommendation text. The server defines a loss function such as cross-entropy between predicted token distributions and target token sequences. During training, the server computes gradients of the loss with respect to model parameters and updates weights using an optimization algorithm such as stochastic gradient descent with adaptive learning rates. The server can also apply regularization techniques, such as dropout in intermediate layers and weight decay, to improve generalization and robustness. Data augmentation techniques, such as paraphrasing prompts or sampling subsets of interest resources, can be used to increase training data diversity.

The server can implement multiple variants of the system. In a first variant, the generative AI model resides in the same computing environment as the server and is accessed via an internal procedure call. In a second variant, the model is located on a separate computation node or external service, and the server communicates with it via a defined API over a network. In another variant, the server uses two different generative AI models: a smaller, faster model for initial summarization of stored resources and a larger, more capable model for final recommendation generation.

The server can also vary the way it constructs prompt sentences. In one mode, the server includes detailed lists of resource titles and short descriptions. In another mode, the server encodes summary statistics of user interest, such as “the user frequently marks budget travel guides and art museum articles as important,” instead of listing all individual resources. Such variations allow the system to balance context richness and computational cost depending on the scenario.

The terminal can be realized as a smartphone, a tablet, a laptop computer, or a desktop computer. The terminal can implement accessibility features such as screen readers or voice-based interfaces. In another embodiment, a vehicle-mounted device acts as the terminal, and the system is used to provide driver-specific recommendations based on previously stored interest indicators and emotional states. In such a case, the server can also interface with sensors and vehicle systems to adjust recommendation timing and modality.

The user, through repeated interaction, indirectly contributes new training data. The user selects or ignores recommended items, and the terminal sends feedback data to the server, which stores such outcomes in the query log table. The server can periodically run an offline analysis process to compute updated preference vectors for each user, based on success rates of past recommendations. These vectors can then be used as additional features in prompt sentences or as input to separate ranking functions. This loop further differentiates the system from a simple automation of human reasoning, as the system uses continuous numerical optimization and large-scale statistical aggregation that are not feasible to perform manually.

Through the combined action of the server, the terminal, and the user interactions, the system realizes a computer-implemented technique that not only automates information retrieval but also modifies the internal operation of the computer system itself for higher efficiency and better personalization. The system reallocates computational work from unstructured query handling to structured, index-based retrieval and context-rich generative processing. This leads to measurable improvements in retrieval speed, accuracy of recommendations, effective bandwidth usage, and user-perceived quality of the presented results.

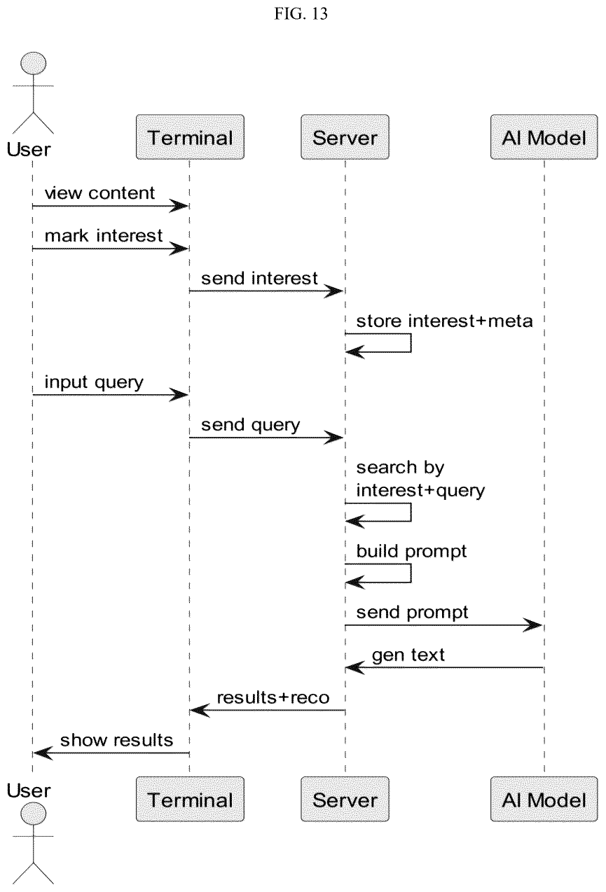

The following describes the processing flow using FIG. 13.

### Step 1:

The user operates the terminal to display an application screen that includes a content view and an interest-assignment control.

The input to this step is the current application state on the terminal and any content item that is being viewed.

The terminal renders the content and displays a control such as a “save,” “favorite,” or “like” button next to each information resource. The user visually recognizes the control as a means to mark interest in the content.

### Step 2:

The user performs an operation for assigning an interest indicator to an information resource via the terminal.

The input to this step is the user's interaction with the terminal, such as a tap, click, or key press on the interest-assignment control associated with a specific information resource.

The terminal detects the event generated by the input device, identifies the corresponding content identifier, and locally constructs an update message that includes at least the user identifier, the content identifier, and an interest indicator value (for example, a binary flag or a rating score). The output of this step is an interest-assignment message stored in the terminal's working memory.

### Step 3:

The terminal transmits the interest-assignment message to the server via a communication interface.

The input to this step is the interest-assignment message generated in Step 2.

The terminal serializes the message into a request payload, encapsulates it in a network protocol request (for example, an HTTP request over a secure channel), and sends it through a wired or wireless network interface. The output of this step is a network request containing the user identifier, the content identifier, and the interest indicator value, delivered to the server

### Step 4:

The server receives the interest-assignment request and updates stored interest data in a storage device.

The input to this step is the network request received through the server's communication interface.

The server parses the request, extracts the user identifier, content identifier, and interest indicator, and then executes a write operation to a data structure such as an interest table. The server either inserts a new record or updates an existing record linking the user and the content with the specified interest indicator. The output of this step is an updated interest record stored in the storage device.

### Step 5:

The server acquires attribute information (metadata) of the information resource and converts it into structured, machine-readable data.

The input to this step is the content identifier extracted in Step 4.

The server queries a content table or content repository to retrieve existing metadata such as title, description, media type, topic category, and timestamps. If needed, the server performs content analysis (for example, keyword extraction or summarization) to generate additional attributes. The server then normalizes these attributes into a predetermined schema, such as a record with defined fields and data types. The output of this step is a metadata record associated with the content identifier and formatted for efficient storage and retrieval.

### Step 6:

The server stores the structured metadata record in the storage device with appropriate indexes.

The input to this step is the metadata record generated in Step 5.

The server writes the metadata record into a content table and updates indexes on fields such as user identifier, content identifier, keywords, and timestamps. These indexes are implemented using data structures such as B-trees or inverted indexes. The output of this step is an updated storage state that allows faster retrieval of content by interest indicator and search conditions.

### Step 7:

The user later operates the terminal to perform a search by entering a character-string search query.

The input to this step is the user's current information need and the displayed search interface on the terminal.

The user types a character string such as “travel plan in Europe” into a search box and activates a search control (for example, pressing an on-screen button or hitting a key). The terminal captures the raw string input as the query text. The output of this step is a query string temporarily stored in the terminal.

### Step 8:

The terminal validates the query string and constructs a search request to send to the server.

The input to this step is the raw query string from Step 7 and the user identifier available in the terminal (for example, from a login session).

The terminal trims whitespace, checks for non-empty content, and may limit query length to a predefined maximum. The terminal then creates a request object that includes the validated query string and the user identifier. The output of this step is a well-formed search request object ready for transmission.

### Step 9:

The terminal transmits the search request to the server over the network.

The input to this step is the search request object created in Step 8.

The terminal formats the request into a network message, encapsulates it in an application-layer protocol message, and sends it through a communication interface using a transport protocol such as TCP. The output of this step is a network message that reaches the server and contains the query string and user identifier.

### Step 10:

The server receives the search request and parses the contained data.

The input to this step is the network message carrying the search request from Step 9.

The server reads the message, validates protocol headers, and extracts the request payload.

The server then parses the payload to obtain the query string and user identifier. The output of this step is a pair of values in server memory: the search query and the user identifier, which will drive subsequent retrieval operations.

### Step 11:

The server normalizes the query string and generates an internal search representation.

The input to this step is the query string obtained in Step 10.

The server converts the query string to a standard form, such as lowercase, and applies tokenization to split the string into individual tokens. The server may remove stop words and apply stemming or lemmatization. The server can then compute vector embeddings for the tokens using a pre-trained embedding model, producing a numerical representation of the query. The output of this step is an internal search representation that may include a token list, a weighted term vector, or a dense embedding vector.

### Step 12:

The server retrieves information resources marked with interest indicators that match the internal search representation.

The input to this step is the internal search representation and the user identifier from Step 11 and Step 10.

The server executes a query against the storage device, filtering by the user identifier in the interest table to obtain candidate content identifiers with interest indicators, and joining these with the content table to access metadata. The server computes a relevance score for each candidate item using the internal search representation and the indexed metadata (for example, by computing cosine similarity between the query embedding and content embeddings or by applying a ranking function). The output of this step is a list of candidate information resources with associated relevance scores and interest indicators.

### Step 13:

The server ranks and selects a subset of the candidate information resources for further processing.

The input to this step is the list of candidates with relevance scores from Step 12.

The server sorts the candidates based on a combined measure of the relevance score and the interest strength (for example, a weighted sum of similarity score and interest level). The server then selects the top N items according to a configurable threshold or limit. The output of this step is a ranked subset of information resources, each with identifiers, titles, short summaries, and computed scores.

### Step 14:

The server accesses past interest history and emotional state information for the user.

The input to this step is the user identifier from Step 10.

The server queries historical data structures such as the query log table and the emotional state table. The server aggregates past interest patterns, for example by counting how often specific categories of content have been marked as important, and retrieves the most recent emotional state indicators. The server may compute summary statistics representing the user's tendency toward certain topics or content types and a compact representation of the emotional state (for example, a pair of numerical values or a discrete label). The output of this step is a set of features describing the user's past interest history and emotional state.

### Step 15:

The server constructs a structured prompt sentence for a generative AI model based on the ranked resources and user history.

The input to this step is the ranked subset of information resources from Step 13 and the user history features from Step 14.

The server selects key attributes from each resource, such as title and a short description, and embeds them into a human-readable but structured template along with the current query and past interest and emotional features. For example, the server can generate a prompt sentence such as:

“The user searched for ‘travel plan in Europe’. The user previously marked the following items as important: (1) ‘Backpacking in Western Europe’—a 10-day itinerary focused on budget travel; (2) ‘City Guide: Paris’—highlights of museums and cafes; (3) ‘Nightlife in Berlin’—clubs and music venues. The user's recent emotional state is relaxed and exploratory. Based on these items and the user's past interest in cultural experiences and budget-conscious trips, recommend new travel information and propose a 7-day itinerary that connects these interests and introduces additional suitable destinations.”

The server thereby transforms structured data (lists of items, scores, and features) into a single, cohesive prompt sentence. The output of this step is a prompt sentence string suitable for input to the generative AI model.

### Step 16:

The server supplies the prompt sentence to the generative AI model and obtains response information.

The input to this step is the prompt sentence created in Step 15.

The server encodes the prompt sentence into tokens according to the model's vocabulary, passes the token sequence to the generative AI model's inference interface, and configures inference parameters such as maximum output length and decoding strategy. The model performs internal computations using its neural network layers and outputs a sequence of tokens representing generated text. The server decodes these tokens back into a text string.

The output of this step is response information that includes recommended items and narrative text, generated by the generative AI model.

### Step 17:

The server post-processes the response information and integrates it with the ranked stored resources.

The input to this step is the generated text from Step 16 and the ranked stored resources from Step 13.

The server analyzes the generated text, for example by segmenting it into recommendation units, extracting named entities such as place names or content types, and optionally correlating these with existing resources in the storage device. The server assembles a composite result structure that places the previously stored, interest-indicated resources alongside or in relation to the newly recommended items, and associates explanatory text with them. The output of this step is a structured result package containing both stored resources and AI-generated recommendations.

### Step 18:

The server formats the structured result package and transmits it to the terminal.

The input to this step is the structured result package built in Step 17.

The server converts the internal representation into a format suitable for transmission and presentation, such as a hierarchy of result entries with titles, summaries, and generated narratives. The server attaches metadata needed for rendering, such as ordering information and display labels. The server then sends this formatted data through the communication interface to the terminal. The output of this step is a response message carrying the integrated search results and recommendation information.

### Step 19:

The terminal receives the response message and renders the integrated results for the user.

The input to this step is the response message from Step 18.

The terminal parses the received data, constructs in-memory objects representing each result entry, and maps these objects to graphical elements on the display. The terminal displays, for example, a section listing previously interest-marked items that match the query and a section presenting AI-generated recommended items and narrative text. The terminal arranges the items according to the ordering specified by the server and provides interaction controls for the user to select, expand, or navigate items. The output of this step is a visual and, optionally, auditory presentation of search results and recommendations that the user can perceive and interact with.

### Step 20:

The user reviews the presented results and optionally provides further interactions that can be used as feedback.

The input to this step is the displayed search and recommendation output from Step 19.

The user may select certain recommended items, ignore others, or perform additional operations such as saving new items or issuing a refined search query. The terminal captures these actions and can send corresponding feedback messages to the server, which can log them for future model improvement and interest-history updates. The output of this step is new interaction data that closes the loop and may be used to continuously refine the behavior of the system.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information recommendation systems typically rely on static matching between user queries and stored content, sometimes augmented by simple collaborative filtering. Such systems have several technical drawbacks from a computer-technology perspective. First, the systems often treat a user's interest signals (for example, flagging or bookmarking operations) as isolated events, and do not normalize or structure the associated metadata into a form that can be efficiently queried and recombined across heterogeneous content types. As a result, server-side storage structures and query execution plans become inefficient when the volume and diversity of content grow, leading to increased latency and higher computational load on storage subsystems.

Second, many existing architectures do not treat emotional information as a first-class signal in the data processing pipeline. Emotional text or similar input from the user is either ignored or processed only at the presentation layer. Consequently, the server cannot systematically use emotion as an index or filter in conjunction with interest history and current queries. This prevents the construction of query plans and recommendation logic that dynamically adapt to the user's changing state, and forces the system to rely on coarse-grained, one-size-fits-all ranking heuristics. This, in turn, increases the number of server client round trips and redundant recommendation computations, thereby reducing throughput and scalability.

Third, when generative AI models are used, they are often invoked with ad-hoc or manually crafted prompts that are not derived in a principled way from the machine-readable state of the system. The server does not maintain a consistent abstraction that transforms structured interaction history and emotional context into prompt sentences. As a result, the generative model is frequently provided with incomplete or noisy context, leading to suboptimal outputs that require additional filtering, recomputation, or post-processing on the server side. This wastes compute resources on the generative model and on the server's application logic, and complicates system integration and maintenance.

Fourth, conventional systems do not provide a unified, time-aware mechanism for continuously collecting and organizing user interaction events (such as indicator assignments and emotional inputs) as chronological history information that can directly drive prompt generation. Without this, the server cannot efficiently generate new, context-rich prompt sentences in response to evolving user behavior, and must either recompute large portions of the recommendation state or store redundant precomputed recommendations. Both approaches degrade storage efficiency and processing performance.

Accordingly, there is a need for an improved computer-implemented system and server architecture that (i) detects and structures user indicator assignments to information objects, (ii) stores and retrieves such structured metadata in a form optimized for subsequent querying, (iii) integrates search terms, past indicators, and emotional state into a unified context for recommendation, and (iv) automatically generates and supplies prompt sentences to a generative AI model based on that context and on chronological history information.

Such a system should reduce redundant computation, improve the efficiency and accuracy of recommendation processing, and provide a technically improved way of orchestrating database retrieval, emotion-aware filtering, and generative-model invocation within a single coherent pipeline.

The specific processing by the specific processing unit 290 of the data processing device 12 in Application Example 2 is realized by the following means.

The present invention provides a server comprising a processor, a storage device, and an interface to a user terminal, wherein the processor is configured to detect, via the terminal, an operation in which a user assigns an indicator to an information object of interest, acquire attribute information regarding the information object, generate structured data based on the attribute information, and store the structured data in the storage device; analyze, when the user inputs a search request or an expression including an emotional state, at least one of a search term and the emotional state included in the input, extract, from the storage device, information elements related to the user, and select recommendation candidate information based on an extraction result and past indicator history of the user; dynamically generate, based on the search term, the past indicator history of the user, the emotional state of the user, and the recommendation candidate information, a prompt sentence for instructing a generative information processing model to generate or recommend related new information, transmit the prompt sentence to the generative information processing model, receive an output result from the generative information processing model, integrate the output result with the recommendation candidate information to construct recommendation information for the user, and transmit the recommendation information for the user to the terminal so that the terminal presents the recommendation information as visual information to the user; and sequentially collect, as events, the indicator assignment operation executed by the user and an input indicating the emotional state of the user, accumulate attribute information corresponding to the events as history information in chronological order in the storage device, and automatically generate the prompt sentence to be used for the generative information processing model from the history information so as to provide, to the user, recommendation information updated in accordance with an elapse of time. This enables the server to maintain a machine-readable, time-aware representation of user interest and emotion, to efficiently retrieve and filter stored information elements, and to invoke a generative AI model with precisely constructed prompt sentences that reflect both current and historical context, thereby improving computational efficiency, scalability, and the technical quality of recommendation output compared with conventional systems.

The term “processor” refers to a hardware or virtual computing element, such as a central processing unit or execution core, configured to execute instructions that implement the functions of detecting user operations, analyzing input, managing storage, generating prompt sentences, communicating with external models, and constructing recommendation information.

The term “storage device” refers to a hardware or logical memory component, such as a non-volatile memory, volatile memory, or database system, configured to store structured data, attribute information, history information, and recommendation information in a machine-readable form.

The term “terminal” refers to an information processing apparatus, such as a client device or user interface device, configured to exchange data with the server, receive recommendation information, and present the recommendation information as visual information to a user.

The term “user” refers to an entity, such as a human individual or an organization, that operates the terminal, performs indicator assignment operations, inputs search requests or emotional expressions, and consumes the recommendation information.

The term “information object” refers to a unit of digital information, such as content or data, including at least one of text, image, audio, or video, for which attribute information is obtainable and which can be targeted by an indicator assignment operation.

The term “indicator” refers to a logical mark or designation associated with an information object, assigned by a user to express interest, preference, or relevance, and used as a basis for constructing past indicator history and recommendation candidate information.

The term “attribute information” refers to descriptive data associated with an information object, such as identification information, classification information, temporal information, or semantic information, which can be acquired, structured, and stored in the storage device.

The term “structured data” refers to data that represents attribute information and related fields in a predefined, machine-readable format, such as a record, tuple, or object having distinct fields suitable for indexing, querying, and analysis by the processor.

The term “search request” refers to an input operation performed by the user, including at least one search term or query condition, which instructs the processor to retrieve related information elements from the storage device.

The term “search term” refers to a string or symbol sequence included in a search request, representing keywords, phrases, or other conditions used by the processor to identify and retrieve related information elements.

The term “emotional state” refers to a psychological or affective condition of the user, such as happiness, sadness, or excitement, which is inferable from an input expression and usable as a parameter for information extraction, filtering, and recommendation.

The term “input expression” refers to user-provided content, including text, voice, or other representational data, that may contain at least one of a search term and an indication of the user's emotional state.

The term “information element” refers to a unit of stored data derived from structured data in the storage device, representing at least one information object or attribute set that is retrievable and usable in recommendation processing.

The term “recommendation candidate information” refers to a set of information elements selected by the processor from the storage device based on an extraction result and past indicator history, prior to integration with an output result of a generative information processing model.

The term “past indicator history” refers to chronologically recorded data representing previous indicator assignment operations of the user, including associated attribute information of information objects and timing information, stored in the storage device.

The term “generative information processing model” refers to a computational model, such as a generative artificial intelligence model, configured to generate new information or recommendations in response to a prompt sentence supplied by the processor.

The term “prompt sentence” refers to a machine-readable instruction sequence, typically expressed in natural language or a structured format, generated by the processor to provide context and directives to the generative information processing model for generation or recommendation tasks.

The term “output result” refers to data supplied by the generative information processing model in response to a prompt sentence, including generated text, structured recommendations, or other informational content usable by the processor.

The term “recommendation information” refers to information constructed by the processor by integrating recommendation candidate information and an output result of the generative information processing model, and intended to be presented to the user via the terminal.

The term “visual information” refers to data output in a form perceivable by sight, such as graphical user interface elements, text displays, or images, that are presented on a display of the terminal.

The term “event” refers to a recordable occurrence related to user interaction, including at least one of an indicator assignment operation and an input indicating an emotional state, which is collected and stored as part of history information.

The term “history information” refers to accumulated data representing a sequence of events and associated attribute information, ordered in time, stored in the storage device for subsequent analysis and prompt sentence generation.

The term “chronological order” refers to an arrangement of history information such that events and their corresponding attribute information are stored or processed according to their temporal sequence.

The term “context” refers to combined information, including at least one of search terms, past indicator history, and emotional state of the user, that characterizes the state in which the generative information processing model is invoked and that influences the generation or recommendation performed by the model.

In one embodiment, a server cooperates with a terminal operated by a user to implement the claimed system. The server includes at least one processor, a main memory, a non-volatile storage device, and a network interface. The terminal includes a display device, an input device, a local processor, and a communication interface. The server executes application software implemented, for example, as a web application using a general-purpose programming language such as a scripting language and a web framework such as a lightweight HTTP framework. The server further accesses a database management system such as a relational database engine (for example, an engine compatible with SQL, such as an embedded database engine or a client-server database engine) and optionally a message streaming platform such as a distributed log system (for example, a publish-subscribe messaging system). The server also communicates with an external generative AI model through an application programming interface.

The server stores, in the storage device, one or more data structures that represent information objects, user indicator assignments, emotional inputs, and generative model interactions. The server uses, for example, relational tables defined in a relational database to hold structured data. The server may maintain a table “Content” with fields such as content_id, type (text, image, audio, video), title, category, tags, creation_time, and normalized semantic features.

The server may maintain a table “UserIndicatorHistory” with fields such as user_id, content_id, indicator_type, timestamp, emotion_label, and context_vector_id. The server may maintain a table “PromptLog” with fields such as prompt_id, user_id, prompt_sentence, context_summary, model_parameters, and generation_timestamp. The server indexes these tables on user_id, content_id, timestamp, and emotion_label, so that the processor can perform efficient range scans and joins when constructing recommendation information.

The terminal provides a user interface that allows the user to browse information objects, assign indicators (such as favorites or likes) to information objects, and input search terms or emotional expressions. The terminal sends user operations to the server as network messages using a communication protocol such as HTTP over a transport protocol. The terminal represents user operations as structured messages, for example, JSON payloads, that include at least the user identifier, the identifier of the information object, and metadata describing the type of operation (indicator assignment, search query, emotional text input, or combined query and emotion input). The terminal receives recommendation information from the server and renders the recommendation information on the display as visual information, using, for example, a browser runtime with a scripting engine.

The server detects the indicator assignment operation when the terminal transmits a message indicating that the user has assigned an indicator to a particular information object. The server extracts the content_id and user_id from the message and retrieves the corresponding attribute information from the Content table. The server normalizes the attribute information by applying a data processing pipeline that may include textual tokenization, lowercasing, stop-word removal, and embedding into a vector representation using a pre-trained text embedding model. The server further encodes categorical attributes (such as genre or content type) into numerical feature vectors, for example using one-hot encoding or learned embeddings. The server then combines these features into structured data, represented as a record in the UserIndicatorHistory table, and stores the record in the storage device.

The server acquires emotional information from the user when the terminal transmits an input expression that contains text such as “I am happy” or “I feel sad.” The server may optionally use an emotion classification model that is distinct from the generative AI model. The server can implement this emotion classification using, for example, a neural network model having an embedding layer, one or more recurrent or transformer-based layers, and a softmax output layer that produces probability scores for emotion classes such as happiness, sadness, anger, or excitement. The server feeds the tokenized text into this emotion classifier, obtains an emotion_label, and stores the emotion_label, together with the indicator event or search request, as part of the structured data in the UserIndicatorHistory table. The server may also compute and store a dense emotion vector representing the distribution over emotion classes.

The server maintains a chronological sequence of events for each user by ordering entries in the UserIndicatorHistory table by timestamp. The server thereby forms history information that captures the evolution of user interest and emotional state over time. The server may also maintain aggregated representations, such as per-user interest profiles, by periodically computing statistical summaries or learned representations (for example, averaging content embeddings for all content with positive indicators or performing incremental matrix factorization). The server uses these chronological and aggregated structures as part of the context for prompt generation.

The server generates a prompt sentence for a generative AI model by combining the user's current search term, the user's past indicator history, and the user's emotional state. The server first queries the storage device to retrieve a subset of events from the UserIndicatorHistory table that match the current user_id. The server may filter this subset by recency (for example, last 30 days) or by content category (such as “movies” or “travel”).

The server then selects representative items, for example by ranking the events according to a relevance score that combines frequency, recency, and emotion compatibility. The server forms a textual summary of the selected items and the current search term. The server also encodes the emotional state into natural language phrases (for example, “The user is feeling sad” or “The user is in a happy mood”). Using these components, the server constructs a natural language prompt sentence that provides explicit instructions to the generative AI model.

The server can use, as the generative AI model, a neural network architecture having an encoder—decoder or decoder-only transformer structure. The generative AI model may consist of multiple layers of self-attention, feed-forward sublayers, and layer normalization, trained on a large corpus of text data with an autoregressive objective. The server specifies model parameters such as maximum token length, temperature, and top-k or nucleus sampling thresholds in the call. The server encodes the prompt sentence as a sequence of tokens according to the model's vocabulary and transmits these tokens to the model inference service through an API call. The generative AI model then computes context-aware outputs by applying multi-head attention mechanisms over the prompt tokens and by generating continuation tokens according to the learned probability distribution.

The server obtains the output result from the generative AI model as generated text. The server post-processes this text by segmenting the output into candidate recommendation items, for example by splitting on line breaks or by parsing a structured list format if prompted. The server can further match the generated item descriptions against the Content table using approximate string matching or semantic similarity based on content embeddings.

This matching allows the server to map the AI-generated items to concrete information objects already stored in the storage device. When the generative AI model suggests new categories or item types, the server may register new content entries or tag existing entries accordingly.

The server integrates the output result from the generative AI model with recommendation candidate information that was directly derived from the storage device. The server may, for example, assign weights to each recommendation source (database-derived versus AI-generated) and combine them using a ranking function that takes into account similarity scores, predicted user satisfaction scores, and emotion compatibility scores. The server then constructs recommendation information as a list of information elements with associated metadata such as titles, short descriptions, and rationales generated by the AI model. The server serializes this recommendation information into a machine-readable response and transmits the response to the terminal.

The terminal receives the recommendation information and transforms it into visual information suitable for presentation on a display. The terminal may render the information as a list view or tile view, and may visually distinguish items that originate from the generative AI model (for example, by displaying a special icon). The terminal also presents emotion-aware explanations, such as “Recommended because you are happy today and you liked similar action movies in the past,” which are generated by the server or directly by the generative AI model. The user can interact with these recommended items by selecting them for detailed viewing, assigning new indicators, or providing feedback; the terminal transmits these interactions back to the server, thus closing a feedback loop.

In one specific example, the user enters the search term “action movies” together with an emotional expression “I feel excited.” The terminal sends a message containing both the search term and the emotional text to the server. The server classifies the emotional text as “excitement,” retrieves recent indicator events where the user positively flagged action movies, and constructs a prompt sentence such as: “The user searched for ‘action movies’.

The user is in an excited mood. The user previously watched and liked the following movies: ‘Movie A’, ‘Movie B’, ‘Movie C’. As a generative AI model, recommend 5 new action movies that match the user's taste and current mood. For each movie, provide the title and a one-sentence explanation.” The server sends this prompt sentence to the generative AI model, receives a list of suggested titles with explanations, and integrates those suggestions with existing catalog entries. The terminal then displays a combined list of known and newly recommended action movies to the user.

In another example, the user inputs only an emotional expression, such as “I feel very sad these days,” without a specific search term. The terminal transmits this expression to the server. The server determines that the emotional state is “sadness,” retrieves indicator history relating to uplifting or comforting content, and constructs a prompt sentence such as: “The user is feeling sad. The user previously liked uplifting comedy movies and feel-good dramas.

As a generative AI model, propose 5 movies that could help improve the user's mood. Provide the title and a short, friendly explanation for each recommendation.” The generative AI model generates suggestions such as light-hearted comedies and positive documentaries.

The server filters out content associated with negative emotional labels and presents the filtered, uplifting recommendations to the user.

The server improves computer technology in several ways. The server uses a specific structured data schema (Content, UserIndicatorHistory, PromptLog) and chronological history storage to reduce the cost of computing recommendation context at each request. The server avoids recomputing full user profiles by incrementally updating history tables on each indicator assignment and emotional input event. This design reduces database query complexity, shortens query execution times, and lowers memory overhead compared to systems that recompute large recommendation matrices for each request. The server also reduces communication load between the application logic and the generative AI model by constructing compact prompt sentences that summarize the most relevant history, instead of sending raw, large-scale interaction logs. As a result, the system achieves lower latency and more predictable network bandwidth use.

The server performs non-conventional processing to integrate emotional state into recommendation logic. Instead of merely tagging content with emotion labels and filtering at the user interface level, the server encodes emotion as both a symbolic label and a dense feature vector that participates in the construction of prompts and ranking functions. The server thereby modifies the internal computation paths of the recommender, allowing the generative AI model's output distribution to be conditioned on both temporal interest history and emotional signals. This leads to improved precision of recommendations, reduced error rates in matching user mood, and a more efficient use of model inference capacity, because the model is supplied with carefully curated context instead of generic, ambiguous prompts.

The generative AI model is trained, in one embodiment, using a sequence-to-sequence or autoregressive training objective, where the model predicts the next token in a prompt-completion sequence. During training, the model receives supervision on prompt-output pairs that include user context summaries and desired recommendation outputs. The training process minimizes a loss function such as cross-entropy between predicted and ground-truth tokens, and the model parameters are updated by gradient-based optimization methods such as stochastic gradient descent with momentum or adaptive learning-rate algorithms. The training data can be augmented by randomly masking parts of the context or by permuting similar content items, thereby improving the robustness of the model to variations in prompt sentence composition. This technical training procedure results in a model that is specifically adapted to interpret the structured prompts produced by the server and to generate recommendations that align with the internal data structures of the system.

The server uses a non-standard, rule-based prompt composition algorithm rather than relying on generic, hand-written prompts. The prompt composition algorithm selects a fixed number of top-k historical items from the chronological history, constructs category-balanced lists when multiple content types are present, and enforces maximum character limits per section.

The algorithm also enforces specific phrasings, such as “As a generative AI model, recommend . . . ,” which improves the determinism and parsability of model outputs. The server thereby achieves more stable and more machine-usable outputs, which reduces post-processing complexity and error propagation in downstream modules.

In an alternative embodiment, the server uses a message streaming platform to decouple real-time event ingestion from prompt generation. The terminal sends indicator events and emotional inputs as messages to the server. The server acts as a producer to publish these events to a topic. A consumer service running on the server side subscribes to the topic, enriches events with content attributes, and writes them into the UserIndicatorHistory table.

A separate recommendation service reads from this table and generates prompt sentences at predefined intervals or on demand. This architecture enables horizontal scaling of event processing and allows the system to maintain near-real-time histories without locking or contention in the core database, thereby improving throughput and availability.

In another embodiment, the server performs additional pre-filtering before invoking the generative AI model. The server may first compute cosine similarity between the current query embedding and the embeddings of historical content, and restrict the context to the most similar items. The server also may apply emotion-specific thresholds, such that only items whose emotion vectors fall within a predefined angular distance from the current emotion vector are used in the prompt. This pre-filtering reduces the length of prompt sentences while preserving the most relevant context, which improves runtime efficiency of the generative AI model and reduces the likelihood of irrelevant or noisy suggestions.

The system is therefore not limited to abstract data manipulation or business-level optimization. The system defines specific data structures, model architectures, feature encodings, and non-conventional processing flows that improve internal computer operations: database query efficiency, memory usage, network bandwidth, and machine-learning inference efficiency. The cooperation between the server, the terminal, and the generative AI model enables an implementation that a skilled person can realize on general-purpose computing hardware, and that yields measurable technical benefits such as faster response times, higher recommendation accuracy, and reduced computational overhead compared with conventional systems that do not employ structured, emotion-aware prompt generation and integrated generative AI processing.

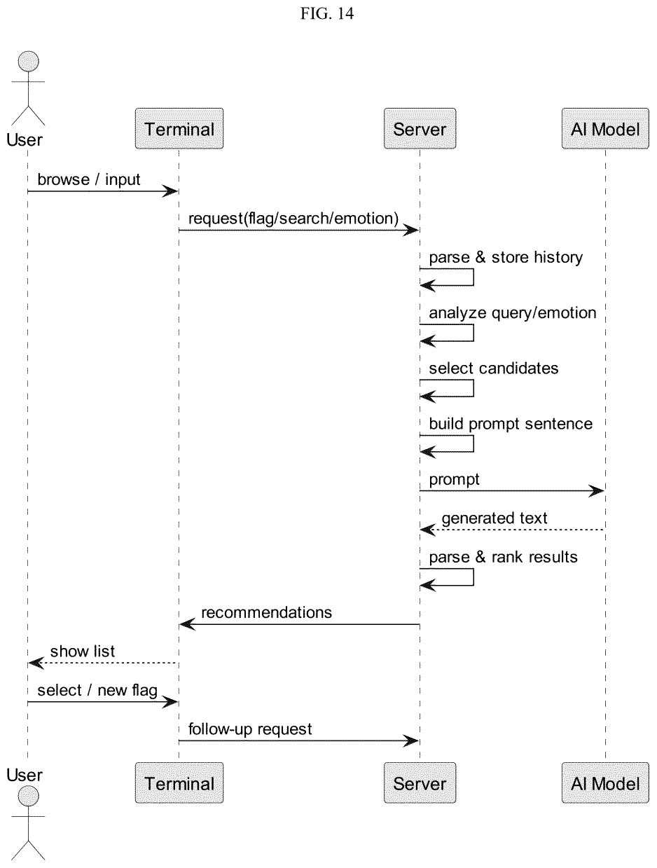

The following describes the processing flow using FIG. 14.

### Step 1:

User operates the terminal to access an application screen that displays a list of information objects and input fields for a search term and an emotional expression.

Input: visual components rendered on the terminal, such as content lists and text boxes.

Output: a user interaction event in which the user selects an information object, enters a search term, and/or enters an emotional expression.

User views the presented information objects, decides which objects are of interest, and performs operations such as clicking a “flag” button, typing a search term (for example, “action movies”), or entering a free-form text indicating an emotional state (for example, “I feel excited”).

### Step 2:

Terminal detects the user interaction event and structures it into a machine-readable request message.

Input: user interaction event including operations such as indicator assignment, search term input, and emotional text input.

Output: a network request message containing fields such as user_id, content_id (if any), indicator_type (if any), search_term (if any), and emotion_text (if any).

Terminal collects the relevant identifiers and text values from the user interface components, converts them into a structured representation (for example, a JSON object), and attaches metadata such as a timestamp.

### Step 3:

Terminal transmits the structured request message to the server via a communication network.

Input: structured request message generated in Step 2.

Output: a network packet containing the request message delivered to the server's network interface.

Terminal opens or reuses a network connection, encapsulates the request message within a protocol such as HTTP over a transport protocol, and sends the message to a predefined server endpoint.

### Step 4:

Server receives the network packet and reconstructs the structured request message from the packet payload.

Input: network packet delivered to the server, containing the request message.

Output: an internal data structure on the server side that represents the request, including user_id, content_id, indicator_type, search_term, and emotion_text.

Server uses a network stack and a web framework to parse the incoming HTTP request, decode the message body (for example, parse JSON), and instantiate a request object in memory that exposes the fields needed for further processing.

### Step 5:

Server determines whether the request includes an indicator assignment operation and, if so, retrieves attribute information for the targeted information object.

Input: internal request object including content_id and indicator_type.

Output: attribute information for the specified information object, such as title, category, tags, and other metadata.

Server constructs and executes a database query against a content table in a storage device, uses the content_id as a key, and retrieves the associated row. Server then maps the row into an attribute object containing normalized fields for subsequent processing.

### Step 6:

Server generates structured data representing the indicator event and stores it in a history table.

Input: attribute object for the information object, user_id, indicator_type, and current timestamp.

Output: a new history record inserted into a UserIndicatorHistory table in the storage device.

Server combines the attribute fields with user_id, indicator_type, and timestamp, optionally applies preprocessing such as text normalization or categorical encoding, and then executes an insertion operation into the history table, thereby extending the chronological history of user interactions.

### Step 7:

Server determines whether the request includes an emotional expression and, if so, performs emotion classification.

Input: emotion_text field from the request object.

Output: an emotion_label (such as “joy” or “sadness”) and optionally an emotion_vector representing a distribution over emotion classes.

Server tokenizes the emotion_text, converts tokens into numerical embeddings, feeds them into an emotion classification model, and computes probability scores over predefined emotion classes. Server selects the class with the highest probability as the emotion_label and may preserve the full probability vector as emotion_vector.

### Step 8:

Server updates the history table with the classified emotional information.

Input: emotion_label and/or emotion_vector together with the relevant history record identifier (for example, the primary key of the indicator event or a separate emotion input event).

Output: a history table entry that includes emotional information associated with the user event.

Server adds or updates fields such as emotion_label and emotion_vector_id in the UserIndicatorHistory table, thereby linking emotional state information to corresponding indicator or query events in chronological order.

### Step 9:

Server determines whether the request includes a search term and, if so, analyzes the term for later retrieval and prompt construction.

Input: search_term from the request object.

Output: a normalized and tokenized representation of the search term, along with associated query parameters.

Server converts the search_term to a canonical form by applying transformations such as lowercasing, stop-word removal, and stemming or lemmatization. Server then tokenizes the normalized term into tokens and may embed the tokens into a vector representation for similarity-based retrieval, producing a query object that encapsulates these derived features.

### Step 10:

Server retrieves related information elements from the storage device based on the search term and user history.

Input: query object derived from the search_term and user_id from the request.

Output: a set of candidate information elements that match the query and are related to the user.

Server executes one or more database queries that filter content by tokens or embeddings, join results with the UserIndicatorHistory table using user_id, and restrict the results according to criteria such as recency, content category, or minimum similarity score. Server constructs a list of candidate information elements from the retrieved rows.

### Step 11:

Server selects recommendation candidate information by combining search-based matches and historical interest patterns.

Input: set of candidate information elements from Step 10 and chronological history records for the same user.

Output: a refined set of recommendation candidate information that reflects both query relevance and past user interest.

Server computes a relevance score for each candidate by aggregating features such as match strength to the search_term, frequency and recency of prior indicators for similar content, and compatibility with the current emotion_label if available. Server sorts candidates by score and selects a subset that will be used in constructing recommendation information and the prompt sentence.

### Step 12:

Server constructs a context summary from the user's past indicator history and current emotional state.

Input: chronological history entries for the user and the current emotion_label (if any).

Output: a context summary string or structure describing representative past items and emotional tendencies.

Server identifies a limited number of past items (for example, the top-k most relevant by recency and popularity) and extracts their titles and categories. Server then concatenates these elements into a natural language description of the user's interests and current mood, such as “The user previously liked the following action movies: . . . . The user is currently in an excited mood.”

### Step 13:

Server generates a prompt sentence for the generative AI model using the search term, the context summary, and the recommendation candidate information.

Input: normalized search_term, context summary, and a selected subset of recommendation candidate information.

Output: a prompt sentence that instructs the generative AI model to generate or recommend related new information.

Server formats the input data into a coherent textual instruction, for example: “The user searched for ‘action movies’. The user previously watched and liked the following movies: [list]. The user is feeling excited. As a generative AI model, recommend 5 new action movies that match the user's taste and current mood, and provide for each movie the title and a one-sentence explanation.” Server ensures the prompt sentence respects a maximum length and includes only the most informative history elements.

### Step 14:

Server encodes the prompt sentence and invokes the generative AI model.

Input: prompt sentence generated in Step 13 and model configuration parameters (such as maximum tokens, temperature, and sampling strategy).

Output: an output text sequence generated by the generative AI model.

Server tokenizes the prompt sentence according to the model's vocabulary, packages the tokens with configuration parameters, and sends them to a model inference endpoint through an application programming interface. The generative AI model processes the token sequence with its internal neural network layers and returns a continuation sequence representing generated recommendations and explanations.

### Step 15:

Server parses the output of the generative AI model into distinct recommendation items.

Input: output text sequence returned by the generative AI model.

Output: a list of generated recommendation items, each including at least a title and a description.

Server splits the text based on delimiters such as line breaks or numbered list markers, and for each segment, extracts a candidate title and explanation. Server may apply pattern matching or simple natural language rules to ensure each item has the required fields and discards malformed segments.

### Step 16:

Server maps generated recommendation items to concrete information objects stored in the storage device.

Input: list of generated recommendation items with titles and descriptions, and content metadata stored in the Content table.

Output: a list of mapped information elements where each AI-generated item corresponds to one or more stored information objects.

Server searches the Content table using approximate string matching, token similarity, or embedding-based similarity between generated titles/descriptions and existing content metadata. Server then associates the best-matching content entries with each generated recommendation and records mapping information such as content_id for later presentation and logging.

### Step 17:

Server integrates database-derived recommendation candidates with mapped AI-generated recommendations into final recommendation information.

Input: refined set of recommendation candidate information from Step 11 and mapped AI-generated recommendation items from Step 16.

Output: a unified recommendation information list ordered by a combined ranking criterion.

Server computes a unified ranking score for each entry by combining factors such as search relevance, historical interest relevance, AI confidence as inferred from model output structure, and emotion compatibility. Server merges both sources into a single list, resolves duplicates by favoring higher scores, and assigns display positions to each item according to their scores.

### Step 18:

Server records the prompt sentence and generative AI interaction metadata in a prompt log for future analysis and optimization.

Input: prompt sentence, associated user_id, model configuration parameters, and identifiers of the final recommendation items.

Output: a new prompt log record stored in the PromptLog table in the storage device.

Server creates a record that includes the prompt_sentence, the timestamp, user_id, a summary of the context, and references to the recommended content ids. Server then writes this record to the PromptLog table, enabling subsequent analysis of model performance and prompt effectiveness.

### Step 19:

Server formats the final recommendation information into a response message suitable for the terminal.

Input: unified recommendation information list and any associated rationales or explanations.

Output: a structured response message including recommendation items, their identifiers, metadata, and explanations.

Server converts the list of recommendation items into a structured object, assigns fields such as title, description, thumbnail reference, and indicator status, and serializes the structure using a format such as JSON to create a response payload.

### Step 20:

Server transmits the structured response message to the terminal over the network.

Input: response payload containing recommendation information.

Output: one or more network packets transporting the response payload to the terminal.

Server uses a web framework to construct an HTTP response, sets appropriate headers such as content type, and sends the response via the network interface so that it reaches the terminal's communication interface.

### Step 21:

Terminal receives the response payload and reconstructs the recommendation information.

Input: network packets containing the response payload.

Output: an internal representation of the recommendation information ready for rendering on the display.

Terminal decodes the HTTP response, parses the serialized payload (for example, parses JSON into a data structure), and creates in-memory objects for each recommendation item, preserving attributes such as title, description, and content_id.

### Step 22:

Terminal renders the recommendation information as visual elements on the display and enables further user interaction.

Input: internal representation of recommendation items from Step 21.

Output: updated user interface displaying recommendation items and interactive controls.

Terminal creates visual components, such as list entries or tiles, places the titles and explanations as text labels, and attaches interaction elements such as buttons for “play,” “more details,” or “flag.” Terminal then refreshes the display so that the user can view and interact with the recommended information.

### Step 23:

User observes the recommendations and optionally performs additional operations such as selecting an item, assigning a new indicator, or providing feedback.

Input: visual display of recommendation items and user preferences.

Output: new user interaction events representing selections, additional indicator assignments, or feedback entries.

User reads the explanations, determines which items are appealing, and acts by, for example, clicking to open an item, clicking to flag a recommended item as a favorite, or entering textual feedback such as “This was helpful.”

### Step 24:

Terminal captures these new user interactions and sends corresponding follow-up request messages to the server, thereby extending the history and improving future prompt sentences.

Input: new user interaction events collected after recommendation presentation.

Output: follow-up network request messages including updated indicators, feedback, and possibly new emotional expressions.

Terminal translates the new interactions into structured messages in the same format as in Step 2, attaches timestamps and relevant identifiers, and transmits them to the server. These follow-up messages then become inputs to subsequent executions of Steps 4 through 18, enabling continuous refinement of user history, prompt sentence composition, and generative AI-based recommendations.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

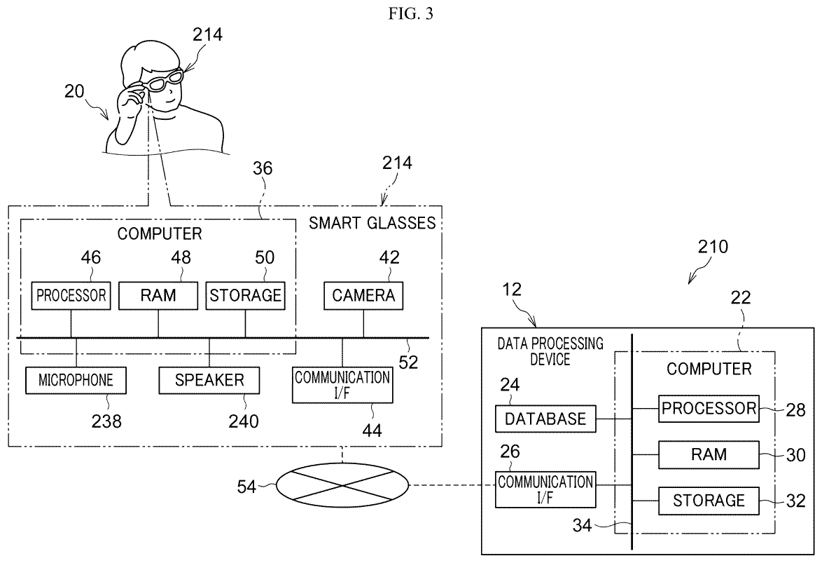

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

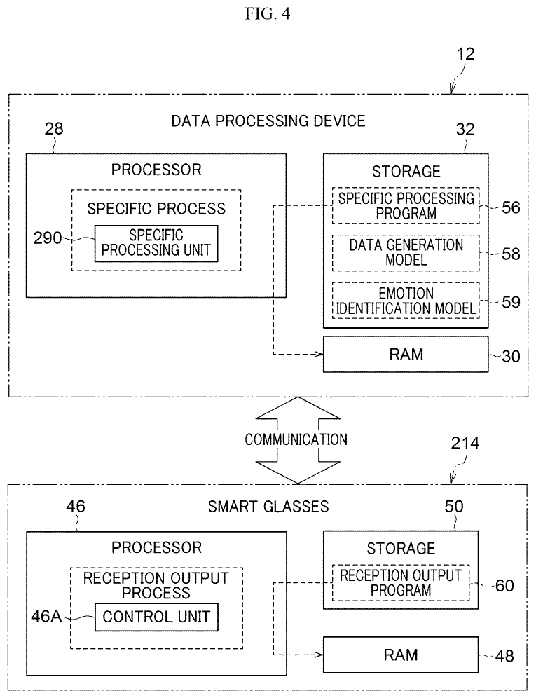

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

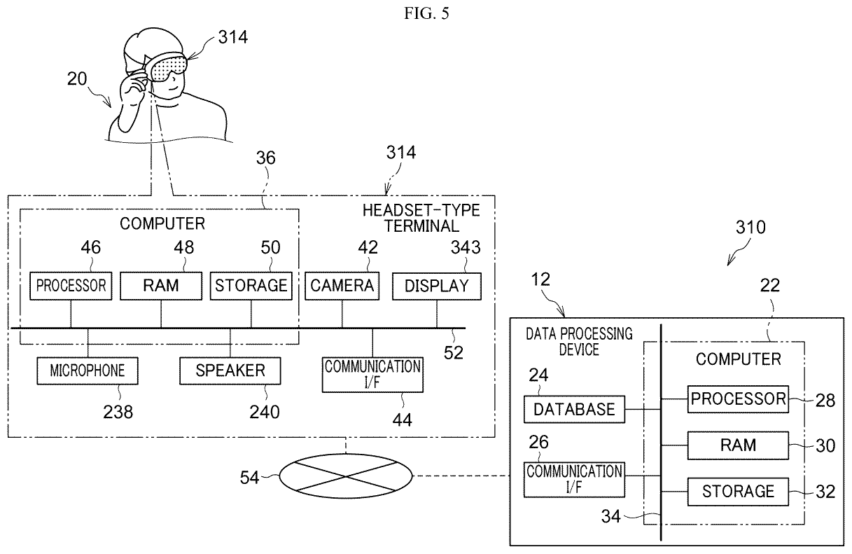

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

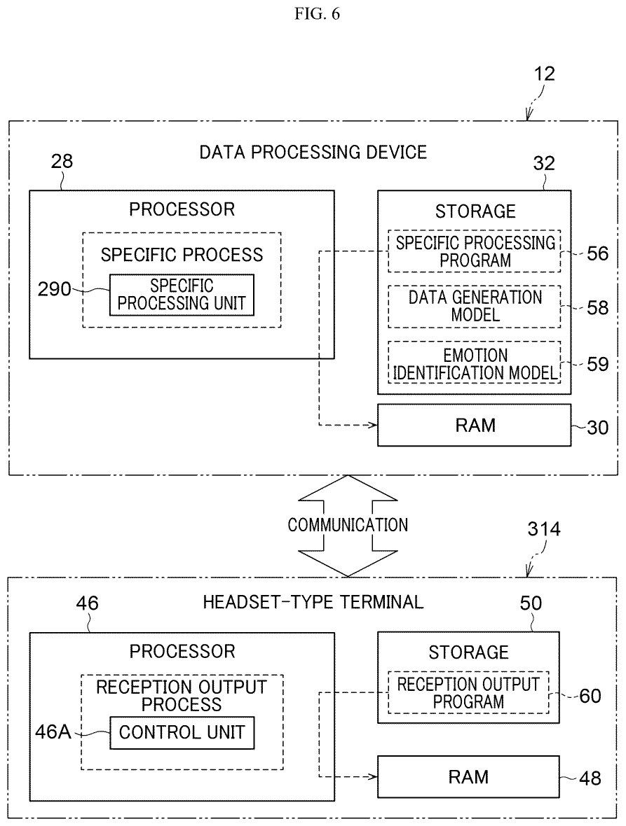

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314.

In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

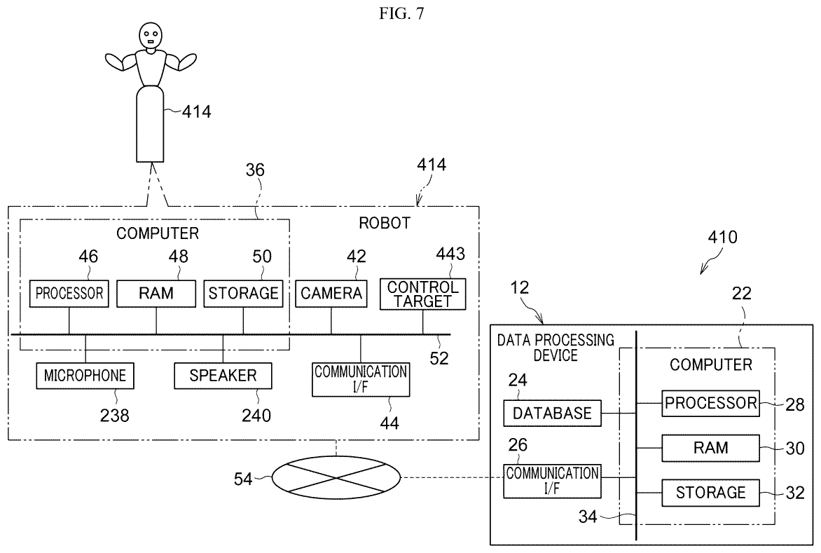

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

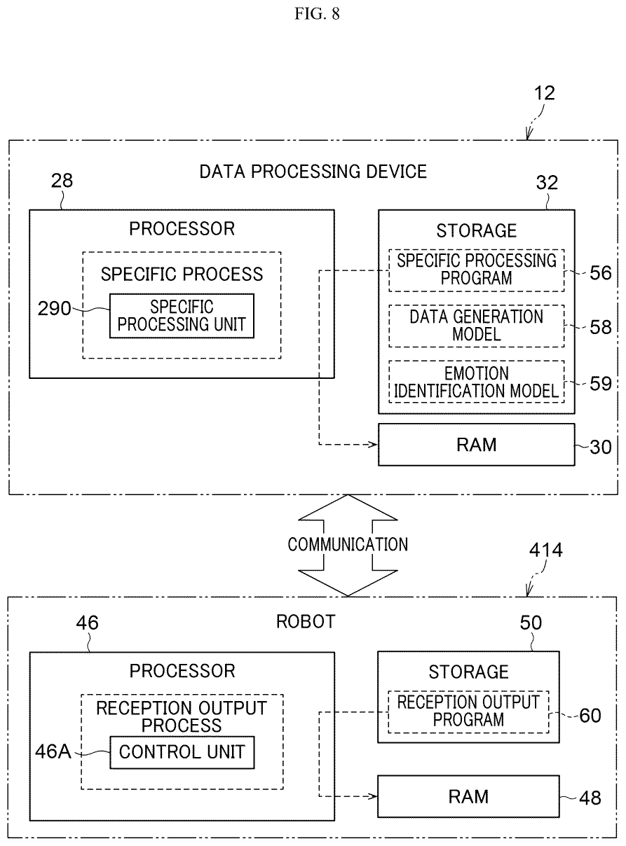

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

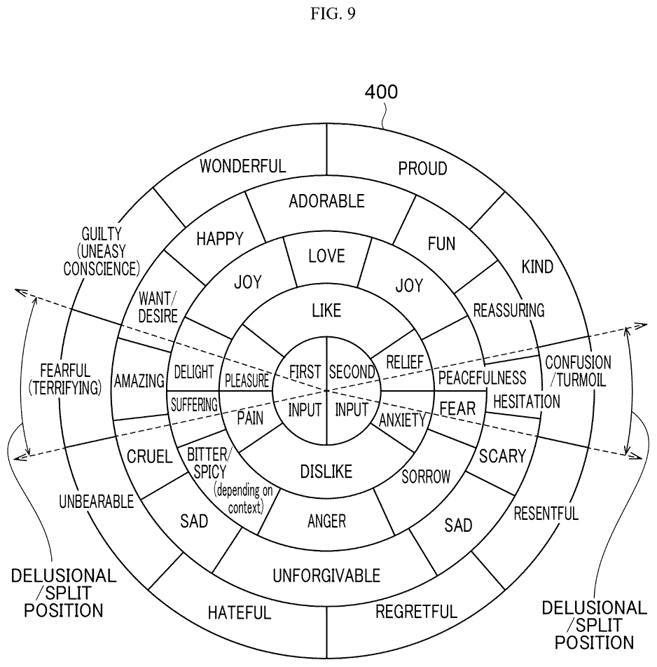

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

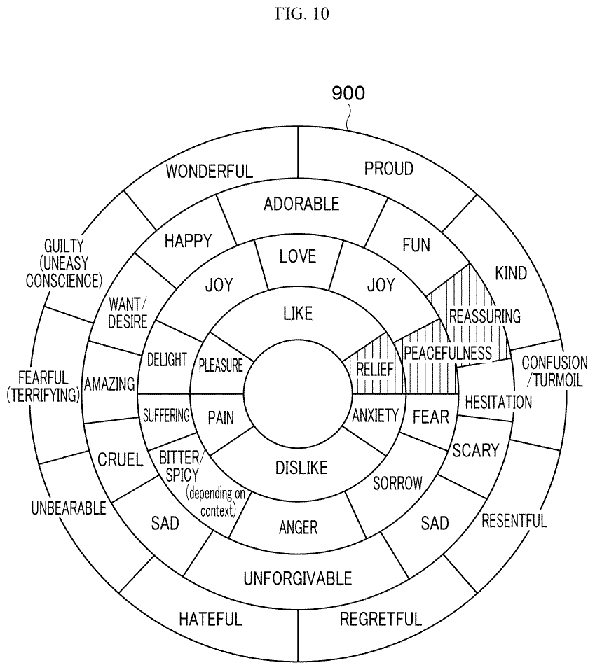

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
detect, from an information processing terminal, a flagging operation performed by a user on electronic information displayed on the information processing terminal, acquire associated information including identification information, presentation information, and reference information corresponding to the electronic information from the information processing terminal, and convert the associated information into a structured data format,
add user identification information and time information to the associated information converted into the structured data format, transmit the associated information with the user identification information and the time information to an external information storage device via a communication network, and register the associated information as stored information managed on a per-user basis in the external information storage device,
receive a retrieval request based on the user identification information, acquire the stored information from the external information storage device in response to the retrieval request, generate list information using the associated information included in the stored information, and transmit the list information to the information processing terminal, and
generate an instruction sentence to be input to a generative information processing model based on the stored information and the retrieval request so that the instruction sentence instructs generation or recommendation of new related information associated with a past interest tendency and an emotional state of the user.

### (Supplementary 2)

The system according to supplementary 1,
wherein the processor is configured to
extract, from the associated information included in the stored information, at least one of a type of the electronic information, a representation format of the electronic information, and an emotion-related attribute of the electronic information, and dynamically generate the instruction sentence such that the instruction sentence instructs the generative information processing model to generate or recommend personalized information including at least one of text information, image information, sound information, moving image information, and a combination thereof based on an extraction result.

### (Supplementary 3)

The system according to supplementary 1,
wherein the processor is configured to
analyze at least one of a search term and condition information included in the retrieval request, correct the instruction sentence to be input to the generative information processing model based on an analysis result and the stored information, and control the generative information processing model to generate or recommend related information according to a relatedness to the stored information and a degree of match to the retrieval request based on the corrected instruction sentence.

### Application Example 1

### (Supplementary 1)

A system comprising a processor and a storage device,
wherein the processor is configured to
detect an operation in which a user, via an information processing terminal, indicates interest in a presented information resource, and acquire attribute information including identification information, reference information, classification information, and time information corresponding to the information resource, and generate the attribute information as structured data,
store the structured data in a recording area of the storage device as an information set indexed by a user identifier, and, when a search request is input from the user, analyze character string information constituting the search request and extract, from the storage device, structured data of the information resources corresponding to the user identifier and the character string information,
generate interest profile data representing a field of interest and a usage tendency of the user on the basis of the structured data recorded in the storage device and search history information and reference history information collected from the user,
automatically generate a prompt sentence, which is an instruction sentence for causing a generative artificial intelligence model to generate candidates of related new information resources, on the basis of the interest profile data and context information representing a current search situation, and form the prompt sentence as request data to be input to the generative artificial intelligence model,
analyze recommendation information output from the generative artificial intelligence model in response to the prompt sentence, structure the recommendation information as recommendation information objects including title information, summary information, and candidate information sources, transmit a search request to an external information providing apparatus when necessary, acquire location information of actual information resources, and associate the location information with the recommendation information objects to generate recommendation result data presentable to the user,
integrate the structured data of the information resources extracted on the basis of the search request with the recommendation result data as display data, transmit the display data to the information processing terminal, and provide, through display control on the information processing terminal, a user interface that enables the user to re-refer to the information resources and discover new information resources, and
record, in the storage device as behavior history information, an operation content and structured data of a target information resource when the user performs a new interest-indicating operation or a reference operation on an information resource included in the recommendation result data, and update learning data for reflection in generation of the interest profile data and the prompt sentence.

### (Supplementary 2)

The system according to supplementary 1,
wherein the processor is configured to
generate the prompt sentence such that the prompt sentence includes, in natural language, the interest profile data including generalized categories of user interest fields, a group of titles of recently recorded information resources, and a group of recent search terms, and further includes constraint conditions specifying a number of recommendation information objects to be output, a length of each summary sentence, and types of candidate information sources.

### (Supplementary 3)

The system according to supplementary 1,
wherein the processor is configured to
cause at least a part of the structured data and the recommendation information objects to correspond to information resources expressed as character information, image information, audio information, video information, or a combination thereof, and, in generating the interest profile data, use medium-type information of the information resources and estimation information regarding an emotional state of the user so as to generate recommendation result data individually adjusted according to the medium type and the emotional state.

### Example 2

### (Supplementary 1)

A system comprising a processor,
wherein the processor is configured to
detect, via a terminal operated by a user, an operation for assigning an interest indicator to an information resource in which the user has interest, and acquire attribute information related to the information resource, convert the attribute information into data, and store the data in a storage device; and
receive, via a communication path, request data including a character-string search query and user identification information input by the user through the terminal, analyze the character-string search query to generate a search condition, and extract, from the storage device, one or more related information resources based on the interest indicator and the search condition; and
generate, based on information relating to the extracted information resources and a past interest history of the user, a prompt sentence for causing a generative artificial intelligence model to recommend related new information, and instruct that the prompt sentence be supplied to the generative artificial intelligence model; and
transmit, to the terminal, the information relating to the extracted information resources and response information obtained from the generative artificial intelligence model, and cause the terminal to output the information as search results formatted in a presentation format for the user.

### (Supplementary 2)

The system according to supplementary 1,
wherein the processor is configured to generate the prompt sentence so as to include the character-string search query input by the user through the terminal, summary information of the information resources extracted from the storage device, and indicator information representing a past emotional state of the user, and to instruct the generative artificial intelligence model, based on the prompt sentence, to generate recommendation information and summary information adapted to a preference of the user.

### (Supplementary 3)

The system according to supplementary 1,
wherein the processor is configured to automatically execute, as a series of processing steps, acceptance of the search query from the user, extraction of the information resources in the storage device based on the search query, generation of the prompt sentence, and acquisition of the response information from the generative artificial intelligence model, and to integrate information resources to which the user has assigned the interest indicator with related information recommended by the generative artificial intelligence model, and present integrated results to the user via the terminal.

### Application Example 2

### (Supplementary 1)

A system comprising a processor, a storage device, and a terminal,
wherein the processor is configured to
detect, via the terminal, an operation in which a user assigns an indicator to an information object of interest, acquire attribute information regarding the information object, generate structured data based on the attribute information, and store the structured data in the storage device,
analyze, when the user inputs a search request or an expression including an emotional state, at least one of a search term and the emotional state included in the input, extract, from the storage device, information elements related to the user, and select recommendation candidate information based on an extraction result and past indicator history of the user, dynamically generate, based on the search term, the past indicator history of the user, the emotional state of the user, and the recommendation candidate information, a prompt sentence for instructing a generative information processing model to generate or recommend related new information, transmit the prompt sentence to the generative information processing model, receive an output result from the generative information processing model, and integrate the output result with the recommendation candidate information to construct recommendation information for the user, and
transmit the recommendation information for the user to the terminal so that the terminal presents the recommendation information as visual information to the user.

### (Supplementary 2)

The system according to supplementary 1,
wherein the processor is configured to include, in the prompt sentence to be provided to the generative information processing model, the search term of the user, the past indicator history of the user, and the emotional state of the user as context for the generative information processing model, and provide, to the terminal, recommendation information adjusted to an interest and the emotional state of the user based on the output result obtained from the generative information processing model.

### (Supplementary 3)

The system according to supplementary 1,
wherein the processor is configured to sequentially collect events based on the indicator assignment operation executed by the user and an input indicating the emotional state of the user, accumulate attribute information corresponding to the events as history information in chronological order, and automatically generate the prompt sentence to be used for the generative information processing model from the history information so as to provide, to the user, recommendation information updated in accordance with an elapse of time.

What is claimed is:

1. A system comprising:
circuitry configured to:
receive, via a communication interface coupled to a packet-switched network, event data indicating a flagging operation performed by a user on electronic content displayed on a terminal device, and acquire associated metadata comprising identification data, presentation data, and reference data corresponding to the electronic content;
convert the associated metadata into a structured data format, add user identification data and time data to the converted associated metadata, and transmit the converted associated metadata to an external storage device via the communication interface;
receive a retrieval request comprising the user identification data from the terminal device, retrieve stored metadata records from the external storage device based on the user identification data, generate list data from the retrieved stored metadata records, and transmit the list data to the terminal device; and
generate an instruction sentence for a generative neural network model based on the stored metadata records and the retrieval request, wherein the instruction sentence specifies generation of related content data associated with a stored interest pattern and a user state parameter of the user, and input the instruction sentence to the generative neural network model.

2. The system according to claim 1, wherein the circuitry is configured to extract the associated metadata by parsing attribute fields of the electronic content including a content identifier, a presentation title, and a source reference, and apply a schema mapping algorithm to convert the parsed attribute fields into records conforming to a predefined structured data schema.

3. The system according to claim 2, wherein the circuitry is configured to add a timestamp and a session identifier to each record prior to transmission to the external storage device, and maintain an index of stored records keyed by the user identification data and the timestamp in the external storage device.

4. The system according to claim 3, wherein the circuitry is configured to receive an updated flagging operation from the terminal device, extract updated associated metadata from the updated flagging operation, merge the updated associated metadata into the stored records indexed by the user identification data, and update the index in the external storage device.

5. The system according to claim 1, wherein the circuitry is configured to parse the retrieval request to extract one or more query terms, apply a retrieval algorithm to the stored metadata records using the query terms as retrieval parameters, rank retrieved records based on a relevance score computed from the query terms and metadata attributes, and include the ranked records in the list data.

6. The system according to claim 5, wherein the circuitry is configured to generate the instruction sentence by combining a prompt template with a representation of the stored metadata records, wherein the prompt template specifies an analysis directive for the generative neural network model to identify patterns in the stored interest data and generate related content suggestions.

7. The system according to claim 6, wherein the circuitry is configured to receive content data from the generative neural network model in response to the instruction sentence, transmit the content data to the terminal device, and store the content data in the external storage device in association with the user identification data and time data.

8. The system according to claim 7, wherein the circuitry is configured to receive implicit feedback data from the terminal device indicating user interaction with the transmitted content data, update the stored metadata records based on the implicit feedback data, and regenerate the instruction sentence incorporating the updated stored metadata records to refine subsequent content generation by the generative neural network model.

9. The system according to claim 1, wherein the circuitry is configured to receive user state data from the terminal device comprising interaction history data and input pattern data, apply an estimation model to the user state data to generate the user state parameter, and incorporate the user state parameter into the instruction sentence as a contextual condition for the generative neural network model.

10. The system according to claim 9, wherein the circuitry is configured to classify the user state parameter into one of a plurality of state categories, select a content generation strategy from a plurality of content generation strategies based on the classified state category, and adjust the instruction sentence to reflect the selected content generation strategy.

11. The system according to claim 10, wherein the circuitry is configured to detect a change in the user state parameter exceeding a state-change threshold between consecutive retrieval requests, regenerate the instruction sentence to incorporate the updated user state parameter, and input the regenerated instruction sentence to the generative neural network model.

12. The system according to claim 1, wherein the circuitry is configured to maintain, in the external storage device, a per-user history of instruction sentences and content data received from the generative neural network model, and incorporate a subset of the per-user history as context data in subsequent instruction sentences to improve consistency of generated content data across retrieval sessions.

13. The system according to claim 12, wherein the circuitry is configured to apply a relevance-filtering algorithm to the per-user history to select a subset of stored records most relevant to a current retrieval request, incorporate only the selected subset as context data in the instruction sentence, and limit instruction sentence length to a predetermined token budget.

14. The system according to claim 1, wherein the circuitry is configured to receive a multi-modal retrieval request from the terminal device specifying a query in at least one of text format, image format, or audio format, apply a modality-specific encoding algorithm to the multi-modal retrieval request to generate a unified query representation, and use the unified query representation as a retrieval parameter in the retrieval algorithm.

15. The system according to claim 14, wherein the circuitry is configured to generate a multi-modal instruction sentence incorporating the unified query representation and the stored metadata records, input the multi-modal instruction sentence to the generative neural network model, and receive multi-modal content data comprising at least one of text data, image data, audio data, or video data for transmission to the terminal device.

16. The system according to claim 1, wherein the circuitry is configured to aggregate stored metadata records across a plurality of users sharing a common attribute, apply a pattern extraction algorithm to the aggregated records to identify shared interest patterns, and incorporate the shared interest patterns as additional context in instruction sentences generated for individual users within the plurality of users.

17. The system according to claim 1, wherein the circuitry is configured to apply an anomaly detection algorithm to newly received associated metadata to detect records deviating from stored interest patterns by more than a deviation threshold, generate an alert message when a deviation exceeding the deviation threshold is detected, and transmit the alert message to a designated management terminal.

18. A system comprising:
circuitry configured to:
receive, via a communication interface coupled to a packet-switched network, event data indicating a flagging operation performed by a user on electronic content, and acquire associated metadata comprising identification data, presentation data, and reference data;
convert the associated metadata into a structured data format and store the converted associated metadata in an external storage device indexed by user identification data and time data;
receive a retrieval request, apply a retrieval algorithm to retrieve stored metadata records from the external storage device, and generate list data for transmission to a terminal device; and
generate an instruction sentence for a generative neural network model by combining a prompt template with a representation of the stored metadata records and a user state parameter, and input the instruction sentence to the generative neural network model to obtain related content data for transmission to the terminal device.

19. The system according to claim 18, wherein the circuitry is configured to receive implicit feedback data from the terminal device indicating user interaction with the transmitted content data, update the stored metadata records based on the implicit feedback data, and regenerate the instruction sentence incorporating the updated stored metadata records.

20. A method performed by circuitry, the method comprising:
receiving, via a communication interface coupled to a packet-switched network, event data indicating a flagging operation performed by a user on electronic content displayed on a terminal device, and acquiring associated metadata comprising identification data, presentation data, and reference data corresponding to the electronic content;
converting the associated metadata into a structured data format, adding user identification data and time data to the converted associated metadata, and transmitting the converted associated metadata to an external storage device via the communication interface;
receiving a retrieval request comprising the user identification data from the terminal device, retrieving stored metadata records from the external storage device based on the user identification data, generating list data from the retrieved stored metadata records, and transmitting the list data to the terminal device; and
generating an instruction sentence for a generative neural network model based on the stored metadata records and the retrieval request, wherein the instruction sentence specifies generation of related content data associated with a stored interest pattern and a user state parameter of the user, and inputting the instruction sentence to the generative neural network model.
